(19) United States
(12) Patent Application Publication
(10) Pub. No.: US 2026/0299742 A1
(43) Pub. Date: Oct. 1, 2026

(54) APPARATUSES, COMPUTER-IMPLEMENTED METHODS, AND SYSTEMS FOR DEFINING A FRICTIONLESS INTEGRATED USER INTERFACE IN ASSOCIATION WITH A USER-ACCESSED APPLICATION AND AN EMBEDDED APPLICATION

(71) Applicant: ATLASSIAN PTY LTD., Sydney (AU)

(72) Inventors: Elsie Ruoxi Wang, New York, NY (US); Marie Casabonne, Oakland, CA (US); Tyler Justin Wilman, Vancouver (CA); Jensen Bouzi, Austin, TX (US); Corina Lawu, Foster City, CA (US)

(21) Appl. No.: 19/092,359

(22) Filed: Mar. 27, 2025

(51) Int. Cl. G06F 3/0481; G06F 3/04845

(52) U.S. Cl. CPC G06F 3/0481; G06F 3/04845; G06F 2203/04803

(57) ABSTRACT

Methods, apparatuses, and computer program products for defining a frictionless integrated user interface for rendering in association with a user-accessed application and an embedded application are provided. Exemplary methods include outputting a user-accessed application user interface for display within an application display window, the user-accessed application user interface configured to access and display user-accessed application source data of the user-accessed application, receiving a contextual embedded application access request, accessing embedded application source data via a data-driven connection between the applications, and causing transformation of the application display window to define the frictionless integrated user interface. This interface defines a modified user-accessed application user interface positioned proximate an embedded application access interface within the application display window, thereby enabling updating of the user-accessed application source data based on user interaction with the modified user-accessed application user interface and the embedded application source data based on user interaction with the embedded application access interface.

### CROSS-REFERENCE TO RELATED APPLICATIONS

This application is related to U.S. Pat. No. 11,044,348, filed on Nov. 5, 2020, as U.S. patent application Ser. No. 17/090,648, and is entitled “SYSTEM, METHOD, AND COMPUTER PROGRAM PRODUCT FOR IMPROVED EMBEDDED APPLICATION DATA MANAGEMENT,” which patent is incorporated by reference herein in its entirety.

### TECHNOLOGICAL FIELD

Embodiments of the present disclosure generally relate to improved user interfaces for software applications, and more particularly to defining a frictionless integrated user interface that enables access to and updating of user-accessed application source data and embedded application source data without context-switching.

### BACKGROUND

Various methods, apparatuses, and systems provide tools for users to plan, coordinate, track, manage, collaborate, and/or otherwise monitor projects and tasks across multiple software application tools. Applicant has identified a number of deficiencies and problems associated with effectively and efficiently enabling users to view and interact with the functionality of the multiple discrete software application tools due to the complexity of managing multiple application windows or contexts without constantly requiring context-switching between or otherwise disabling access to the different application windows Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

The present disclosure contemplates improved methods, apparatuses, computer program products, systems, and/or the like that leverage a data-driven connection for defining a frictionless integrated user interface to effectively and efficiently enable updating of user-accessed application source data based on user interaction with a modified user-accessed application user interface and embedded application source data based on user interaction with an embedded application access interface, the modified user-accessed application user interface and the embedded application access interface defined by the frictionless integrated user interface within a single application display window.

According to one aspect of the present disclosure, a computer-implemented method for defining a frictionless integrated user interface for rendering in association with a user-accessed application and an embedded application is provided. The method includes outputting a user-accessed application user interface for display within an application display window, wherein the user-accessed application user interface is configured to access and display user-accessed application source data of the user-accessed application supported by a first executable user-accessed application code base, and wherein the user-accessed application user interface comprises an embedded application engagement component. The method further includes receiving a contextual embedded application access request in response to user interaction with the embedded application engagement component of the user-accessed application user interface, wherein the contextual embedded application access request corresponds to the embedded application supported by a second executable embedded application code base. The method also includes accessing, via a data-driven connection between the user-accessed application and the embedded application, embedded application source data based on the contextual embedded application access request. Additionally, the method includes causing transformation of the application display window to define a frictionless integrated user interface, wherein the frictionless integrated user interface defines a modified user-accessed application user interface positioned proximate an embedded application access interface within the application display window, wherein the frictionless integrated user interface is configured to enable updating of the user-accessed application source data based on user interaction with the modified user-accessed application user interface, and the embedded application source data based on user interaction with the embedded application access interface.

In some embodiments, causing transformation of the application display window to define a frictionless integrated user interface may comprise programmatically relocating or removing one or more data objects of the user-accessed application source data from the user-accessed application user interface to define the modified user-accessed application user interface as a first side panel component, defining the embedded application access interface as a second side panel component, and defining the frictionless integrated user interface with a side-by-side view of the modified user-accessed application user interface and the embedded application access interface. Programmatically relocating or removing one or more data objects of the user-accessed application source data from the user-accessed application user interface may comprise one or more of generating a mobile view of the user-accessed application user interface, removing a navigation panel from the user-accessed application user interface, or relocating, removing, or modifying an issue context panel user-accessed application user interface.

In some embodiments, the user-accessed application user interface may comprise a full-screen issue view for a project management application and the embedded application may comprise a collaboration application.

In some embodiments, the contextual embedded application access request may comprise a create embedded application content request or an access linked embedded application content request.

In some embodiments, the frictionless integrated user interface may include a resizable boundary between the modified user-accessed application user interface and the embedded application access interface.

In some embodiments, the method may further include receiving an expand embedded application interface request and causing transformation of the application display window to define an updated frictionless integrated user interface by adjusting the resizable boundary to increase a size of the embedded application access interface. In other embodiments, the method may also include receiving a minimize embedded application interface request and causing transformation of the application display window to define an updated frictionless integrated user interface by adjusting the resizable boundary to decrease a size of the embedded application access interface and replacing the modified user-accessed application user interface with the user-accessed application user interface. In still other embodiments, the frictionless integrated user interface may comprise an embedded application tabbed interface engagement component, and the method may further include receiving a generate new embedded application tabbed interface request in response to user interaction with embedded application tabbed interface engagement component of the frictionless integrated user interface, and causing transformation of the application display window to define the user-accessed application user interface in a first tabbed interface component and define the embedded application access interface in a second tabbed interface component.

In some embodiments, causing transformation of the application display window to define the frictionless integrated user interface may comprise automatically adjusting a layout of the modified user-accessed application user interface and the embedded application access interface based at least in part on an application display window width in pixels.

According to another aspect of the present disclosure, an apparatus for defining a frictionless integrated user interface for rendering in association with a user-accessed application and an embedded application is provided. The apparatus comprises a processor and a memory storing instructions that, when executed by the processor, cause the apparatus to output a user-accessed application user interface for display within an application display window, wherein the user-accessed application user interface is configured to access and display user-accessed application source data of the user-accessed application supported by a first executable user-accessed application code base, and wherein the user-accessed application user interface comprises an embedded application engagement component. The apparatus is further caused to receive a contextual embedded application access request in response to user interaction with the embedded application engagement component of the user-accessed application user interface, wherein the contextual embedded application access request corresponds to the embedded application supported by a second executable embedded application code base. The apparatus is also caused to access, via a data-driven connection between the user-accessed application and the embedded application, embedded application source data based on the contextual embedded application access request. Additionally, the apparatus is caused to cause transformation of the application display window to define a frictionless integrated user interface, wherein the frictionless integrated user interface programmatically relocates or removes one or more data objects of the user-accessed application source data from the user-accessed application user interface to define a modified user-accessed application user interface positioned proximate an embedded application access interface within the application display window, wherein the frictionless integrated user interface is configured to enable updating of the user-accessed application source data based on user interaction with the modified user-accessed application user interface, and the embedded application source data based on user interaction with the embedded application access interface.

In some embodiments, the instructions to cause transformation of the application display window to define a frictionless integrated user interface may comprise instructions that, when executed by the processor, cause the apparatus to define the modified user-accessed application user interface as a first side panel component, define the embedded application access interface as a second side panel component, and define the frictionless integrated user interface with a side-by-side view of the modified user-accessed application user interface and the embedded application access interface.

In some embodiments, the user-accessed application user interface may comprise a full-screen issue view for a project management application and the embedded application may comprise a collaboration application.

In some embodiments, the instructions to programmatically relocate or remove one or more data objects of the user-accessed application source data from the user-accessed application user interface may comprise instructions that, when executed by the processor, cause the apparatus to perform one or more of generating a mobile view of the user-accessed application user interface, removing a navigation panel from the user-accessed application user interface, or relocating, removing, or modifying an issue context panel user-accessed application user interface.

In some embodiments, the contextual embedded application access request may comprise a create embedded application content request or an access linked embedded application content request.

In some embodiments, the frictionless integrated user interface may include a resizable boundary between the modified user-accessed application user interface and the embedded application access interface.

In some embodiments, the memory may store further instructions that, when executed by the processor, cause the apparatus to receive an expand embedded application interface request and cause transformation of the application display window to define an updated frictionless integrated user interface by adjusting the resizable boundary to increase a size of the embedded application access interface. In other embodiments, the memory may store further instructions that, when executed by the processor, cause the apparatus to receive a minimize embedded application interface request and cause transformation of the application display window to define an updated frictionless integrated user interface by adjusting the resizable boundary to decrease a size of the embedded application access interface and replacing the modified user-accessed application user interface with the user-accessed application user interface. In still other embodiments, the frictionless integrated user interface may comprise an embedded application tabbed interface engagement component, and the memory may store further instructions that, when executed by the processor, cause the apparatus to receive a generate new embedded application tabbed interface request in response to user interaction with embedded application tabbed interface engagement component of the frictionless integrated user interface, and cause transformation of the application display window to define the user-accessed application user interface in a first tabbed interface component and define the embedded application access interface in a second tabbed interface component.

In some embodiments, the instructions to cause transformation of the application display window to define the frictionless integrated user interface may comprise instructions that, when executed by the processor, cause the apparatus to automatically adjust a layout of the modified user-accessed application user interface and the embedded application access interface based at least in part on an application display window width in pixels.

According to another aspect of the present disclosure, a computer program product comprising at least one non-transitory computer-readable storage medium having computer-readable program code portions stored therein is provided. The computer-readable program code portions comprise executable portions configured to output a user-accessed application user interface for display within an application display window, wherein the user-accessed application user interface is configured to access and display user-accessed application source data of a user-accessed application supported by a first executable user-accessed application code base, and wherein the user-accessed application user interface comprises an embedded application engagement component. The executable portions are further configured to receive a contextual embedded application access request in response to user interaction with the embedded application engagement component of the user-accessed application user interface, wherein the contextual embedded application access request corresponds to an embedded application supported by a second executable embedded application code base, and wherein the contextual embedded application access request comprises a create embedded application content request or an access linked embedded application content request. The executable portions are also configured to access, via a data-driven connection between the user-accessed application and the embedded application, embedded application source data based on the contextual embedded application access request. Additionally, the executable portions are configured to cause transformation of the application display window to define a frictionless integrated user interface, wherein the frictionless integrated user interface defines a modified user-accessed application user interface positioned proximate an embedded application access interface within the application display window, wherein the frictionless integrated user interface is configured to enable updating of the user-accessed application source data based on user interaction with the modified user-accessed application user interface, and the embedded application source data based on user interaction with the embedded application access interface.

In some embodiments, the executable portions configured to cause transformation of the application display window to define a frictionless integrated user interface may comprise executable portions configured to programmatically relocate or remove one or more data objects of the user-accessed application source data from the user-accessed application user interface to define the modified user-accessed application user interface as a first side panel component, define the embedded application access interface as a second side panel component, and define the frictionless integrated user interface with a side-by-side view of the modified user-accessed application user interface and the embedded application access interface.

In some embodiments, the user-accessed application user interface may comprise a full-screen issue view for a project management application and the embedded application may comprise a collaboration application.

In some embodiments, the executable portions configured to programmatically relocate or remove one or more data objects of the user-accessed application source data from the user-accessed application user interface may comprise executable portions configured to perform one or more of generating a mobile view of the user-accessed application user interface, removing a navigation panel from the user-accessed application user interface, or relocating, removing, or modifying an issue context panel user-accessed application user interface.

In some embodiments, the frictionless integrated user interface may include a resizable boundary between the modified user-accessed application user interface and the embedded application access interface.

In some embodiments, the computer program product may further comprise executable portions configured to receive an expand embedded application interface request and cause transformation of the application display window to define an updated frictionless integrated user interface by adjusting the resizable boundary to increase a size of the embedded application access interface. In other embodiments, the computer program product may further comprise executable portions configured to receive a minimize embedded application interface request and cause transformation of the application display window to define an updated frictionless integrated user interface by adjusting the resizable boundary to decrease a size of the embedded application access interface and replacing the modified user-accessed application user interface with the user-accessed application user interface. In still other embodiments, the frictionless integrated user interface may comprise an embedded application tabbed interface engagement component, and the computer program product may further comprise executable portions configured to receive a generate new embedded application tabbed interface request in response to user interaction with embedded application tabbed interface engagement component of the frictionless integrated user interface, and cause transformation of the application display window to define the user-accessed application user interface in a first tabbed interface component and define the embedded application access interface in a second tabbed interface component.

In some embodiments, the executable portions configured to cause transformation of the application display window to define the frictionless integrated user interface may comprise executable portions configured to automatically adjust a layout of the modified user-accessed application user interface and the embedded application access interface based at least in part on an application display window width in pixels.

The above summary is provided merely for purposes of summarizing some example embodiments in a simplified form to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. This summary is not intended to identify key features or essential features of the claimed subject matter, nor is it intended to be used as an aid in determining the scope of the claimed subject matter. Other features, aspects, and advantages of the subject matter will become apparent from the description, the drawings, and the claims. The foregoing general description of the illustrative embodiments and the following detailed description thereof are merely exemplary aspects of the teachings of this disclosure and are not restrictive.

### BRIEF DESCRIPTION OF FIGURES

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the drawings:

FIG. 1 illustrates an example computer system environment within which various example embodiments of the subject disclosure may operate;

FIG. 2 is a schematic block diagram of example circuitry of an example user-accessed application server to perform various operations in accordance with various embodiments of the subject disclosure;

FIG. 3 is a schematic block diagram of example circuitry of an example embedded application server to perform various operations in accordance with various embodiments of the subject disclosure;

FIGS. 4A-4H illustrate example user interfaces structured in accordance with various example embodiments of the subject disclosure;

FIG. 5A is a flowchart illustrating example operations for defining a frictionless integrated user interface in accordance with various aspects and embodiments of the subject disclosure;

FIG. 5B is a signal diagram of an example data flow for defining a frictionless integrated user interface in accordance with various example embodiments of the subject disclosure;

FIG. 6 is a flowchart illustrating example operations for transforming an application display window to define a frictionless integrated user interface in accordance with various example embodiments of the subject disclosure;

FIG. 7 is a flowchart illustrating example operations for expanding an embedded application access interface in accordance with various example embodiments of the subject disclosure;

FIG. 8 is a flowchart illustrating example operations for minimizing an embedded application access interface in accordance with various example embodiments of the subject disclosure; and

FIG. 9 is a flowchart illustrating example operations for defining a user-accessed application user interface and an embedded application access interface in new tabbed interface components in accordance with various example embodiments of the subject disclosure.

### DETAILED DESCRIPTION

One or more embodiments now will be more fully described with reference to the accompanying drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard). It should be understood that some, but not all embodiments are shown and described herein. Indeed, the embodiments may be embodied in many different forms, and accordingly this disclosure should not be construed as limited to the embodiments set forth herein. Rather, the description also encompasses combinations and modifications to those exemplary aspects described herein and these embodiments are provided so that this disclosure will satisfy applicable legal requirements. As used herein, the description may refer to a server or client device as an example “apparatus.” However, elements of the apparatus described herein may be equally applicable to the claimed system, method, and computer program product. Accordingly, use of any such terms should not be taken to limit the spirit and scope of embodiments of the present disclosure.

### Overview

Methods, apparatuses, systems, and computer program products are provided in accordance with example embodiments of the present disclosure in order to address technical problems and critical challenges in modern digital workspaces, particularly the complexities arising from using multiple application tools in, for example, project development and management. In today's collaborative environments, individuals and organizations routinely use functionality spread across multiple tools to plan, track, organize, schedule, collaborate, and/or otherwise manage one or more development projects, such as agile software development projects. With such dispersion of functionality and information in conventional systems, users frequently encounter difficulties when trying to view the plurality of user interfaces in order to perform their work and document it simultaneously.

Conventional “siloing” of software applications creates user experience issues and although certain software applications may be developed to enable interaction(s) and/or data interoperability with other software applications (e.g., a first software application designed to call, or retrieve data from, a second software application to accomplish various tasks or operations), common workflows may require the contexts of two or more applications to be simultaneously viewable and editable. Current user experiences are fraught with challenges, primarily due to the necessity of context-switching between different application windows or “contexts”. Users often resort to makeshift solutions, such as manually and laboriously creating side-by-side views of different applications. This approach creates unnecessary friction and continues to introduce several pain points, including the need for manual resizing of windows, precise positioning of application interfaces, and management of excessive tab clutter. These workarounds are time-consuming, prone to errors, and significantly hamper productivity. In addition, accessing or interacting with the user interface of one application tool disables access to any other user interfaces of other application tools until the user explicitly interacts with such other user interfaces.

Embodiments of the present disclosure address the various deficiencies set forth above and others described herein by removing the friction between such applications and their user interfaces and seamlessly introduces a frictionless integrated user interface and using a data-driven connection between an embedded application and a user-accessed application, the frictionless integrated user interface defining a modified user-accessed application user interface positioned proximate an embedded application access interface within a single application display window. The frictionless integrated user interface of the present disclosure is configured to enable updating of the user-accessed application source data based on user interaction with the modified user-accessed application user interface, and the embedded application source data based on user interaction with the embedded application access interface, reducing or otherwise eliminating the need for manual context-switching or creation of makeshift multi-window views. in some embodiments, this integrated arrangement of the application user interfaces in the frictionless integrated user interfaces is achieved through sophisticated programmatic transformations of the application display window, ensuring optimal use of screen real estate and maintaining the context and access to functionality of both applications. For example, in some embodiments of the present disclosure, to work on a project, a user may require simultaneous access to a user-accessed application user interface of a user-accessed application (e.g., Jira Software® (JSW) by Atlassian, Jira Service Management® (JSM) by Atlassian, Jira Work Management® (JWM) by Atlassian, etc.) and the user interface of an embedded application (e.g., Confluence® by Atlassian). A data-driven connection established between the user-accessed application and the embedded application enables interoperability between the user-accessed application and the embedded application, including access to the embedded application source data by the user-accessed application. In various embodiments, the application display window is transformed from displaying a user-accessed application user interface with an embedded application engagement component to defining the frictionless integrated user interface of the present disclosure.

The technical advantages of this solution are significant. The frictionless integrated user interface is configured to enable updating of both the user-accessed application source data and the embedded application source data based on user interactions with their respective interfaces. Crucially, this is achieved without mutual interference between the applications, allowing users to seamlessly access and utilize the functionality of both applications within a unified interface. This innovative approach not only streamlines workflows but also enhances collaboration by providing a cohesive environment where users can efficiently manage, update, and interact with diverse types of project-related information. By eliminating the need for constant application switching and manual window management, the various embodiments of the present disclosure significantly reduce cognitive overhead, improve productivity, and minimize the risk of errors associated with fragmented information management in complex project environments.

The integration of the user-accessed application and embedded application functionalities within a single application display window with the ability to update the user-accessed application source data based on user interaction with the modified user-accessed application user interface and the embedded application source data based on user interaction with the embedded application access interface substantially improves user efficiency by eliminating the need for constant context-switching between separate application windows and reducing the time and cognitive overhead typically necessitated by conventional multi-application workflows. Additionally, the dynamic nature of the frictionless integrated user interface offers a scalable solution that can be adapted for various screen sizes and user preferences, ranging from side-by-side views to minimized and expanded states. The versatility of the interface components, such as resizable boundaries and tabbed interfaces, allows for customization based on specific user requirements, further enhancing the practical utility of the frictionless integrated user interface. Furthermore, the frictionless integrated user interface minimizes the risk of data loss or inconsistency between applications, ensuring the integrity of information across both the user-accessed application and embedded application. These technical advantages collectively contribute to a state-of-the-art solution for integrated application interfaces that is both efficient and adaptable to diverse user needs and workflows.

It should be appreciated that embodiments disclosed herein provide for user-accessed applications and embedded applications in any of a myriad of contexts. In some example contexts, for example, the embedded application and the user-accessed application may be controlled by a single entity or otherwise part of a single suite of software tools. In another context, an embedded application and a user-accessed application may be controlled by separate entities. For example, an entity controlling a user-accessed application may enable access to functionality of an embedded application controlled by another entity for any of a myriad of business reasons (e.g., to increase revenue by incentivizing use of advanced features requiring payment by a user) and/or technical reasons (e.g., to provide access to complementary functionality upon which the embedded application is based). In addition, while the embodiments disclosed herein discuss a frictionless integrated user interface configured for integrating access to two applications, the present disclosure contemplates expansion of this concept into a broader framework for seamlessly integrating multiple applications within a single interface. In this regard, it should be appreciated that example embodiments may be configured as described herein to provide interoperability between a user-accessed application and embedded application(s) in a manner that provides an improvement to the field of interoperable application data management, as described herein.

Accordingly, frictionless integrated user interfaces structured in accordance with various embodiments of the present disclosure may provide specific, technical solutions to technical problems faced by existing systems, the details of which are described hereafter.

### Example Terminology

As used herein, the term “executable code base” refers to computer program code stored in one or a plurality of locations that is executed and/or executable via one or more computer devices embodied in hardware, software, firmware, and/or any combination thereof. An executable code base defines at least one particular application to be executed by one or more computing devices. In some embodiments, a memory, storage, and/or other computing device includes and/or otherwise is structured to define any number of separate executable code bases (e.g., a first application and a second application, a user-accessed application and an embedded application, or the like). Alternatively or additionally, in some embodiments, separate executable code bases are embodied by separate computing devices (e.g., a first server embodying a first executable code base and a second server embodying a second executable code base). Examples include an executable user-accessed application code base and an executable embedded application code base.

From a technical perspective, an executable code base is typically compiled or interpreted program code that can be run on a computer system. This code may be written in various programming languages such as C++, Java, Python, or JavaScript, and may be organized into modules, classes, or functions that define the application's structure and behavior. The code base may include source code files, compiled binaries, libraries, and any necessary resources or assets required for the application to function.

The term “user-accessed application” refers to a dedicated software program, application, platform, service, web browser, or computer-executable application software supported by, based on, or otherwise embodied by a first executable code base that performs a particular first set of functions and is configured to provide a second set of functions associated with an embedded application supported by, based on, or otherwise embodied by a second executable code base through interaction via a connection with the embedded application, such as a data-driven connection. For example, the user-accessed application may embed access to and/or functionality of an embedded application within an interface along with access to and native functions of the user-accessed application (e.g., presented from within an instance of the user-accessed application).

Users interact with a user-accessed application (e.g., a project management application) through web-based interfaces or dedicated client applications, which may be accessed from, for example, desktop computers, laptops, or mobile devices. That is, users may interact with the user-accessed application through its graphical user interface (e.g., user-accessed application user interface), which may include elements such as buttons, forms, and interactive displays. When a user initiates an action that requires functionality from the embedded application, the user-accessed application interacts with the embedded application via a connection, such as a data-driven connection, and the results of these interactions are then reflected in the graphical user interface (e.g., user-accessed application user interface, frictionless integrated user interface), accordingly, allowing for a seamless user experience with the embedded functionality of the embedded application through the user-accessed application.

In some embodiments, the user-accessed application is a project management application or project management-type application which may be a dedicated software program, application, platform, service, web browser, or computer-executable application software that provides project management functionality such as task assignment, progress tracking, and reporting capabilities in relation to projects. For example, a user may use a project management application for planning, tracking, and managing development projects (e.g., software development projects), as well as other types of work. Non-limiting examples of a project management application or project management-type application include Jira Software® and Jira Work Management® by Atlassian®, in which users are able to track and manage stories, issues, bugs, and tasks within a software project. In some embodiments, a project management application may include a distributed network of servers and databases to handle the storage, processing, and retrieval of project-related data and a project management application may utilize application programming interfaces (APIs) and microservices architecture to enable integration with various internal and external tools and applications.

In some embodiments, the user-accessed application may include hardware, software, or combinations thereof operating remotely (e.g., on a server). In some embodiments, the user-accessed application is designed to execute on a client device such as a mobile device (e.g., tablets or smartphones). For example, in certain embodiments, an app is provided that executes on mobile device operating systems such as iOS®, Android®, or Windows®. These platforms typically provide frameworks that allow apps to communicate with one another and with particular hardware and software components of mobile devices. For example, the mobile operating systems named above each provide frameworks for interacting with location services circuitry, wired and wireless network interfaces, user contacts, and other applications. Communication with hardware and software modules executing outside of the app is typically provided via application programming interfaces (APIs) provided by the mobile device operating system.

The term “embedded application” refers to a dedicated software program, application, platform, service, web browser, or computer-executable application software supported by, based on, or otherwise embodied by an executable code base that performs a particular second set of functions and is configured to be accessed at least through a user-accessed application supported by, based on, or otherwise embodied by a separate executable code base from that of the embedded application. The functionality and corresponding user interface(s) of an embedded application are displayed in association with or otherwise presented from within an instance of a first software application (e.g., a user-accessed application). For example, access to and/or functionality associated with an embedded application may be embedded into an interface comprising functionality of a user-accessed application. In some embodiments, such separate applications are associated with dedicated and distinct data repositories for each application, such that functionality made available via embedding is controlled by each of the separate applications from within the user-accessed application as described herein. In some embodiments, an embedded application is accessible directly as well as through a user-accessed application. Further details regarding user-accessed applications, embedded applications, data-driven connections, and otherwise provisioning embedded application access are described in U.S. Pat. No. 11,044,348, which was filed as U.S. application Ser. No. 17/090,648 on Nov. 5, 2020, and is entitled “SYSTEM, METHOD, AND COMPUTER PROGRAM PRODUCT FOR IMPROVED EMBEDDED APPLICATION DATA MANAGEMENT”, which patent is incorporated by reference herein in its entirety.

A non-limiting example of an embedded application may be a collaboration application, which refers to a software tool designed for knowledge management, content creation, and to otherwise facilitate teamwork, communication, and information sharing among users. A collaboration application typically provides a centralized platform for creating, organizing, editing, and managing various types of content and workflows within an organization or team. A non-limiting example of a collaboration application includes Confluence® by Atlassian®.

The term “user-accessed application repository” refers to a location, such as a database stored on a memory device, which is accessible by one or more computing devices for retrieval and storage of various types of data related to the user-accessed application, such as user-accessed application source data (e.g., issue data associated with an issue in a project management application), executable user-accessed application code base, application settings, user preferences, application state information, user-generated content, and data generated or manipulated by the user-accessed application.

The user-accessed application repository may be a dedicated device and/or part of a larger repository and may include cloud-based storage solutions or hybrid systems that combine on-premises storage with cloud backups. The user-accessed application repository may be dynamically updated or may be static. In some embodiments, the user-accessed application repository is encrypted in order to limit unauthorized access of data associated with the project management application. The data stored in the user-accessed application repository may be organized into tables, collections, or file structures depending on the type of database system used. User-accessed application repositories include encryption, logical security controls, disparate storage containers, firewalls, and sophisticated access rights protocols that ensure that user-accessed applications repositories remain distinct from embedded application repositories even in distributed multi-tenant cloud database architectures.

Interaction with the user-accessed application repository occurs through database queries or API calls from the user-accessed application. When a user performs an action in the application that requires data retrieval or storage, the user-accessed application sends a request to the user-accessed application repository, which processes the request and returns the appropriate response. The user-accessed application repository may also implement caching mechanisms to improve performance for frequently accessed data.

The term “user-accessed application source data” refers to data associated with a user-accessed application that is stored and maintained within a user-accessed application repository. For example, the user-accessed application source data informs the user-accessed application user interface or otherwise provides the content to be displayed to users in the user-accessed application user interface. From a technical standpoint, user-accessed application source data encompasses a wide range of data types and structures that are essential for the functioning of the user-accessed application, such as user-accessed application objects. For example, in a project management application, these objects might include, but are not limited to, projects, tasks, issues, users, team members, comments, project identifiers, issue identifiers, etc. User-accessed application source data is created, updated, or otherwise edited through the user-accessed application user interface. When a user interacts with the application, these operations are translated into database queries or API calls that modify the underlying source data. Each object may have associated attributes and relationships with other objects, forming a complex data model that underpins the user-accessed application's functionality.

The term “embedded application repository” refers to a location, such as a database stored on a memory device, which is accessible by one or more computing devices for retrieval and storage of various types of data related to the embedded application, such as embedded application source data (e.g., issue brainstorm data associated with an issue page in a collaboration application), executable embedded application code base, application settings, user preferences specific to the embedded application, user-generated content, and data generated or manipulated by the embedded application.

The embedded application repository may be a dedicated device and/or part of a larger repository and may include cloud-based storage solutions or hybrid systems that combine on-premises storage with cloud backups. In some embodiments, an embedded application repository may be hosted on separate servers from the user-accessed application repository. The embedded application repository may be dynamically updated or may be static. In some embodiments, the embedded application repository is encrypted in order to limit unauthorized access of data associated with the embedded application. The data stored in the embedded application repository may be organized into tables, collections, or file structures depending on the type of database system used.

Interaction with the embedded application repository occurs through database queries or API calls from the embedded application. When a user performs an action in the application that requires data retrieval or storage, the embedded application sends a request to the embedded application repository, which processes the request and returns the appropriate response. The embedded application repository may also implement caching mechanisms to improve performance for frequently accessed data. Embedded application repositories include encryption, logical security controls, disparate storage containers, firewalls, and sophisticated access rights protocols that ensure that embedded application repositories remain distinct from user-accessed application repositories even in distributed multi-tenant cloud database architectures.

The term “embedded application source data” refers to data associated with an embedded application that is stored and maintained within an embedded application repository. For example, the embedded application source data informs the embedded application access interface or otherwise provides the content to be displayed to users in the embedded application access interface. From a technical standpoint, embedded application source data encompasses a wide range of data types and structures that are essential for the functioning of the embedded application, such as embedded application objects. For example, in a collaboration application, these objects might include, but are not limited to, document objects, revision histories, user annotations, sharing permissions, project identifiers, issue identifiers, etc. Embedded application source data is created, updated, or otherwise edited through the embedded application access interface. When a user interacts with the embedded application, these operations are translated into database queries or API calls that modify the underlying source data. Each object may have associated attributes and relationships with other objects, forming a complex data model that underpins the embedded application's functionality.

The term “data-driven connection” refers to a configuration and/or mechanism by which a user-accessed application is enabled to access functionality provided by an embedded application. Technically, a data-driven connection is implemented as a software interface that facilitates communication and data exchange between two separate applications or systems. Such software interface may include a set of application programming interface(s) (APIs), protocols, and/or data formats that define how the user-accessed application can request and receive data or invoke functionality from the embedded application. For example, a data-driven connection may refer to a library of one or more APIs that are included in and/or otherwise configured for use by a particular user-accessed application to enable interaction with an embedded application. In some embodiments, the library of APIs are maintained separate from the executable code base embodying the user-accessed application (e.g., executable user-accessed application code base) that, when embedded and/or otherwise integrated into the user-accessed application, enable use of such APIs for interacting with the embedded application. In some embodiments, a data-driven connection includes specially configured software application program(s), interface element(s), and/or other component(s) for embedding within an interface associated with a user-accessed application to provide access to functionality facilitated by the embedded application. In some embodiments, the data-driven connection may operate as one or more APIs that helps communicate programmatically between the user-accessed application and the embedded application such as for handling expected interactions between the two experiences. A data-driven connection between a user-accessed application and an embedded application enables users to view, edit, and create content in the embedded application without leaving their current context and interactivity in the user-accessed application to access the embedded application, providing a seamless experience for the user and maintaining their workflow and productivity.

The term “application display window” refers to a viewport or a visual area within a screen where user interface(s) are displayed to a user. For example, any one or more user interfaces (e.g., user-accessed application user interface, embedded application access interface, frictionless integrated user interface, etc.) may be output for display within an application display window. An application display window may be implemented as a graphical container within a windowing system and contain a rendering surface where the user interface elements are drawn. The application display window also serves as the primary interface for user input. Mouse events, keyboard input, and touch interactions are captured within the bounds of the window and routed to the appropriate UI elements or event handlers within the application(s).

An application display window may be defined by its dimensions (e.g., application display window width and application display window height in pixels) and position on the screen. For example, the application display window width represents the horizontal space available for displaying user interface(s) and content within the current application display window. From a technical standpoint, the application display window width is a dynamic value that can be accessed and monitored through various programming interfaces and used to inform and define the frictionless integrated user interface. In the context of a frictionless integrated user interface, the application display window width might be used to determine how to arrange the modified user-accessed application user interface and the embedded application access interface. In multi-monitor setups, an application display window might span across multiple physical screens. The application display window might dynamically adjust its layout and content based on the available screen space, providing a consistent user experience across different devices and screen sizes.

Notably, application display windows represent a single instance or session of an application user interface. Thus, in multi-tab browser sessions, each tab launched by a browser in the multi-tab browser session embodies a different application display window. When a user navigates between tabs, the user thus navigates between differing application display windows in a process referred to herein as “context switching”.

The term “user-accessed application user interface” refers to a graphical user interface rendered via a user-accessed application. A user-accessed application user interface is rendered to a client device based on data and instructions provided by the user-accessed application (e.g., a user-accessed application server). In some embodiments, such data and instructions are facilitated by a dedicated software application running on the client device. In other embodiments, such data and instructions are provided through a web browser running on the client device.

A user-accessed application user interface is configured to be displayed within an application display window to enable users to view and engage with the user-accessed application and provide access to functionality and data provided by an embedded application associated with the user-accessed application via a data-driven connection. Technically, a user-accessed application user interface is implemented as a collection of visual components and interactive elements that represent the application's functionality and data to the user. In addition to visual components and interactive elements that represent the functionality and data of the user-accessed application to the user, a user-accessed application user interface may initially render or otherwise comprise one or more interactive UI elements (e.g., a button, a menu item, an icon, or any other clickable or tappable element) within the allocated space in the user-accessed application user interface, the one or more interactive UI elements engageable by a user and configured to provide access to and serve as an entry point to the functionality and data provided by an embedded application. For example, the user-accessed application user interface may include any one or more embedded application engagement components, such as a create embedded application content engagement component and/or an access linked embedded application content engagement component, such that when a user interacts with the engagement component (e.g., by clicking or tapping it), it triggers an event handler in the code of the user-accessed application that is responsible for initiating the process of accessing or loading the functionality and data of embedded application (e.g., dynamically generating an embedded application access interface) via the data-driven connection.

A non-limiting example of a user-accessed application user interface is a full-screen issue view in a project management application. For example, a full-screen issue view may provide a visual representation of an individual issue within a project management application, the visual representation organizing and displaying key information and actions related to a specific service ticket or issue from the user-accessed application source data in a logically structured manner. Such full-screen issue view is designed to provide users with contextualized information about the issue, making it easier for them to scan, update, and manage tasks within the project management system. The full-screen issue view may comprise several technical components that work together to present a comprehensive overview of the issue, such as an issue context panel, which displays metadata providing contextual detail about a specific issue or task such as the assignee and status of the issue, and an issue description panel, which contains more extensive information regarding the underlying issue like description, comments, attachments, and sub-tasks and functionally serves as the primary interface for users to interact with and update the content of an issue. The full-screen issue view serves as an interactive interface where users can perform various actions such as editing issue details, adding comments, changing the status, or linking related issues. The full-screen issue view may also include one or more navigation panels, which are user interface components that contain a collection of menu items, enabling users to navigate or access various features and sections of the application and organize their workflow efficiently. In the context of a project management application, the navigation panel may include menu items for accessing the home dashboard, switching between different projects or applications, viewing recently visited items, and accessing starred or favorited pages.

Another non-limiting example of a user-accessed application user interface is a mobile view in a project management application, which refers to an optimized interface designed for viewing and interacting with content, for example, on mobile devices with smaller screens, ensuring a user-friendly experience on smartphones and tablets. A mobile view is a specialized version of a user interface that adapts the layout, content, and functionality of an application to prioritize simplicity, core information, and space efficiency. Some embodiments of the present disclosure wherein a modified user-accessed application user interface is defined for positioning proximate an embedded application access interface may comprise generating a mobile view of a full-screen issue view of the user-accessed application user interface, even in instances of a desktop view. For example, a modified user-accessed application user interface, such as a mobile view, may involve programmatically relocating or reorganizing content blocks or panels (e.g., issue description panel, issue context panel), resizing images, or otherwise hiding or removing non-essential elements (e.g., a navigation panel, issue context panel) thereby prioritizing displaying of critical issue information. Empty fields may be hidden or removed and less frequently used features or further detailed information might instead be accessible through expandable sections to programmatically and simultaneously display the modified user-accessed application user interface and the embedded application access interface.

In some embodiments, such user interaction with an engagement component generates or otherwise initiates a “contextual embedded application access request”, which refers to an electrically generated data structure or other digital object that encapsulates information indicating that a user requests access to the functionality and data of the embedded application via the user-accessed application user interface. A contextual embedded application access request contains contextual information relevant to the request, such as the type of request (e.g., create embedded application content request, access linked embedded application content request, etc.), project or issue association, and/or the like.

The term “create embedded application content request” refers to an example of a contextual embedded application access request. A create embedded application content request is an electrically generated data structure or other digital object created by a computing device that indicates that a user has provided an input comprising a request to create a new page or whiteboard with the embedded application via the user-accessed application user interface. A create embedded application content request contains information relevant to content creation such as the type of content to be created in the embedded application, such as a page or a whiteboard in an embedded collaboration application. The electrically generated data structure of the create embedded application content request is instantiated when a user interacts with a UI element in the user-accessed application user interface designed for creating new content within the embedded application, such as “Create” and/or “Page” or “Whiteboard” buttons or options.

The term “access linked embedded application content request” refers to an example of a contextual embedded application access request. An access linked embedded application content request is an electrically generated data structure or other digital object created by a computing device that indicates that a user has provided an input comprising a request to access linked or otherwise existing content of the embedded application via the user-accessed application user interface. An access linked embedded application content request contains information necessary or relevant to retrieve and display the requested content, such as a unique identifier for the requested content or the type of content being accessed (e.g., a page or a whiteboard in an embedded collaboration application). The electrically generated data structure of the access linked embedded application content request is instantiated when a user interacts with a UI element in the user-accessed application user interface designed for accessing existing content within the embedded application.

The term “embedded application access interface” refers to a graphical user interface of an embedded application and is configured to enable users to view and engage with the embedded application via a user-accessed application. An embedded application access interface may be requested via interaction with an embedded application engagement component displayed to a user-accessed application interface and implemented as a specialized interface component within the framework of the frictionless integrated user interface. The embedded application access interface may be created dynamically when a user requests access to the embedded application via interaction with an embedded application engagement component.

The term “frictionless integrated user interface” refers to an integrated interface (e.g., an embedded application access interface displayed in association with a user-accessed application interface) that is configured to enable updating of user-accessed application source data based on user interaction with a user-accessed application user interface (e.g., a modified user-accessed application user interface) and embedded application source data based on user interaction with an embedded application access interface. A frictionless integrated user interface enables cross-product access to user-accessed application source data in a user-accessed application user interface (e.g., a modified user-accessed application user interface) and embedded application source data in an embedded application access interface without disabling the embedded application and the user-accessed application and without constant switching between the embedded application and the user-accessed application. A frictionless integrated user interface does not require a user to manually open an embedded application access interface in a new tab, manually resize user interface(s), or otherwise drag and position the user interfaces so that both are in view.

Technically, a frictionless integrated user interface is implemented as a composite user interface that seamlessly combines elements from both the user-accessed application and the embedded application within a single coherent interface. The frictionless integrated user interface serves as a bridge between the user-accessed application and the embedded application, providing a seamless way for users to interact with the embedded application's functionality without leaving the context of the user-accessed application. When a user interacts with the frictionless integrated user interface, the project management application handles the complexity of determining which application should respond to the interaction, fetching or updating data as necessary, and updating the display accordingly. This process happens seamlessly, without requiring the user to manually switch contexts or manage separate application windows.

The term “expand embedded application interface request” refers to an electrically generated data structure or other digital object that encapsulates information indicating that a user requests to transition the embedded application access interface to a larger or nearly full-screen interface component within the frictionless integrated user interface. An expand embedded application interface request may be triggered by a user interaction, such as clicking an expand or “Large Preview” button, icon, or menu item in an embedded application access interface control menu displayed after selecting an embedded application access interface control engagement component. An expand embedded application interface request may contain additional metadata, such as the current size, position, and/or state of the embedded application access interface, which can be used to calculate the new dimensions for the expanded view.

The functionality of an expand embedded application interface request may extend beyond simply increasing the size or otherwise adjusting a resizable boundary of an embedded application access interface in some embodiments. For example, in response to receiving an expand embedded application interface request, a project management application may adjust the layout and/or state of the modified user-accessed application user interface in the frictionless integrated user interface to accommodate the larger embedded application view. In some embodiments, this may include defining an updated frictionless integrated user interface and returning the modified user-accessed application user interface to a user-accessed application user interface (e.g., in full-screen issue view) with an embedded application access interface as large preview overlay thereto (e.g., potentially disabling certain interactions with the user-accessed application user interface in the background to focus user attention on the expanded embedded application access interface). The expand embedded application interface request may also trigger additional data fetching or rendering processes to populate the larger view of the embedded application access interface with more detailed information or additional features that were not visible in the smaller embedded application access interface. Alternative implementations of the expand embedded application interface request might include options for different levels of expansion, such as a medium-sized view in addition to a large-sized view.

The term “minimize embedded application interface request” refers to an electrically generated data structure or other digital object that encapsulates information indicating that a user requests to transition or adapt the embedded application access interface to a smaller version or minimized button within the frictionless integrated user interface. A minimize embedded application interface request may be triggered by a user interaction, such as clicking a “Minimize” button, icon, or menu item in an embedded application access interface control menu displayed after selecting an embedded application access interface control engagement component. A minimize embedded application interface request may contain additional metadata, such as the current size, position, and/or state of the embedded application access interface, which can be used to calculate the new dimensions for the minimized view.

The functionality of a minimize embedded application interface request may extend beyond simply decreasing the size, reducing the visual footprint, or otherwise adjusting a resizable boundary of an embedded application access interface in some embodiments. For example, in response to receiving a minimize embedded application interface request, a project management application may adjust the layout and/or state of the modified user-accessed application user interface in the frictionless integrated user interface to accommodate the minimized embedded application view. In some embodiments, this may include defining an updated frictionless integrated user interface and returning the modified user-accessed application user interface to a user-accessed application user interface (e.g., in full-screen issue view) with a collapsed version of the embedded application access interface (e.g., a small icon or button) that can be easily expanded later. The minimize embedded application interface request may also trigger adjustment of the layout and resizable boundary with respect to the user-accessed application user interface to reclaim space previously occupied by the embedded application access interface, returning the user-accessed application user interface to its original state before the embedded application was accessed (e.g., except for the addition of a small icon or button corresponding to the collapsed embedded application access interface). Various embodiment of the minimize embedded application interface request might include options for different levels of minimization, such as a compact view in addition to a fully minimized or collapsed view. The functionality of a minimize embedded application interface request may also implement a docking feature, where the minimized interface attaches to a specific area of the application display window for easy access.

The term “dock to side embedded application interface request” refers to an electrically generated data structure or other digital object that encapsulates information indicating that a user requests to transition the embedded application access interface to side panel component within the frictionless integrated user interface. A dock to side embedded application interface request may be triggered by a user interaction, such as clicking a “Dock to side” button, icon, or menu item in an embedded application access interface control menu displayed after selecting an embedded application access interface control engagement component. A dock to side embedded application interface request may contain additional metadata, such as the current size, position, and/or state of the embedded application access interface, which can be used to calculate the new dimensions for the side panel component view.

The functionality of a dock to side embedded application interface request may extend beyond simply adjusting a resizable boundary of an embedded application access interface in some embodiments. For example, in response to receiving a dock to side embedded application interface request, a project management application may adjust the layout and/or state of the modified user-accessed application user interface in the frictionless integrated user interface to accommodate the side panel component of the embedded application access interface. In some embodiments, this may include defining a frictionless integrated user interface or an updated frictionless integrated user interface and transforming the user-accessed application user interface into a side panel component including a modified user-accessed application user interface. The dock to side embedded application interface request may also trigger additional data fetching or rendering processes to populate the side panel component view of the embedded application access interface with the appropriate information for the side panel component view. Alternative implementations of the dock to side embedded application interface request might include options for different levels of the side panel component, such as varying widths of the side panel component.

The term “embedded application tabbed interface engagement component” refers to a user interface element within the frictionless integrated user interface that allows users to interact with and access the embedded application in a new tabbed interface component. This interactive component typically takes the form of a clickable button, icon, or menu item that, when engaged, triggers the opening of the embedded application in a separate tab. When a user interacts with this component, it generates a “generate new embedded application tabbed interface request” (discussed in the next term). The handling of this request may include creating a new tabbed interface component programmatically and loading the embedded application's content into this new tabbed interface component.

The term “generate new embedded application tabbed interface request” refers to an electrically generated data structure or other digital object created by a computing device that indicates a user's request to open the embedded application access interface in a new tabbed interface component. This request may be triggered when a user interacts with the embedded application tabbed interface engagement component, such as clicking an “Open in new tab” button. The generate new embedded application tabbed interface request may contain information or data necessary to open and initialize the new tabbed interface component, such as a unique identifier or pointer to the embedded application source data to be opened in the new tabbed interface component or a current state or context of the embedded application in the frictionless integrated user interface. For example, the generate new embedded application tabbed interface request may call a function that dynamically constructs both the location of the embedded application source data with a query parameter, the query parameters including a list of one or more arguments or options determined by the user-accessed application and the logic of the embedded application, such as scrolling to a specific location, displaying with or without a page tree, etc. In some embodiments, the embedded application source data in the view of the new tabbed interface component may be the same or similar to those features or source data that is displayed as determined when generating the embedded application access interface, such as access to a page tree setting forth a hierarchy of the pages.

The terms “project identifier” or “project ID” refer to one or more items of data by which a project may be uniquely identified within a project management application and/or collaboration application. For example, a project identifier may comprise one or more of American Standard Code for Information Interchange (ASCII) text, encryption keys, identification certificates, a pointer, Internet Protocol (IP), a URL, a MAC address, a memory address, or other unique identifier, or combinations thereof.

The terms “issue identifier” or “issue ID” refer to one or more items of data by which an issue may be uniquely identified within a project management application and/or collaboration application. For example, an issue identifier may comprise one or more of American Standard Code for Information Interchange (ASCII) text, encryption keys, identification certificates, a pointer, Internet Protocol (IP), a URL, a MAC address, a memory address, or other unique identifier, or combinations thereof.

The terms “user identifier” or “user ID” refer to one or more items of data by which a user may be uniquely identified within a project management application and/or collaboration application. For example, a user identifier may comprise one or more of ASCII text, encryption keys, identification certificates, a pointer, an IP address, a URL, a MAC address, a memory address, or other unique identifier, or combinations thereof.

The terms “user interaction” or “user engagement” refer to user interaction, via a graphical user interface, with an interface or components thereof. Such user engagement or user interaction with the interface or components thereof can be via a multitude of interactions, such as, but not limited to, “non-keystroke engagement” or “keystroke engagement.” Non-keystroke engagement refers to user interaction in which such user interaction is free from (i.e., excludes) the entering of one or more (e.g., keystroke) characters into a user interface. For example, touch-screen or mouse click engagement are examples of non-keystroke engagement. The term “keystroke engagement” refers to entering of one or more keystrokes into a component of the interface. For example, input of one or more characters (e.g., alphanumeric characters or emojis) into a component of the interface is one example of keystroke engagement.

As used herein, the terms “data,” “content,” “digital content,” “digital content object,” “signal,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

Terms such as “computing,” “determining,” “generating,” and/or similar words are used herein interchangeably to refer to the creation, modification, or identification of data.

The term “computer-readable storage medium” refers to a non-transitory, physical or tangible storage medium (e.g., volatile or non-volatile memory), which may be differentiated from a “computer-readable transmission medium,” which refers to an electromagnetic signal.

The term “client device” and similar terms refer to computer hardware and/or software that is configured to access a service made available by a server. The server is often (but not always) on another computer system, in which case the client device accesses the service by way of a network. Client devices may include, without limitation, smart phones, tablet computers, laptop computers, wearables, personal computers, enterprise computers, and the like.

The terms “database,” “repository,” and/or similar terms used herein interchangeable may refer to a collection of records or data that is stored in a computer-readable storage medium using one or more database types. The term “database type” may refer to a type of database, such as a hierarchical database, network database, relational database (e.g., Aurora, RDS), entity-relationship database, object database (e.g., S3), document database, semantic database, graph database, noSqL database (e.g., DynamoDB), and/or the like.

The term “comprising” means including but not limited to and should be interpreted in the manner it is typically used in the patent context. Use of broader terms such as comprises, includes, and having should be understood to provide support for narrower terms such as “consisting of,” “consisting essentially of,” and “comprised substantially of”.

The phrases “in one embodiment,” “according to one embodiment,” “in some embodiments,” and the like generally mean that the particular feature, structure, or characteristic following the phrase may be included in the at least one embodiment of the present disclosure and may be included in more than one embodiment of the present disclosure. Thus, the particular feature, structure, or characteristic may be included in more than one embodiment of the present disclosure such that these phrases do not necessarily refer to the same embodiment. Further, “based on,” “based at least in part on,” “based at least on,” “based upon,” and/or similar words are used herein interchangeably in an open-ended manner such that they do not indicate being based only on or based solely on the referenced element or elements unless so indicated.

The terms “illustrative,” “example,” “exemplary” and the like are used herein to mean “serving as an example, instance, or illustration” with no indication of quality level. Any implementation described herein as “exemplary” is not necessarily to be construed as preferred or advantageous over other implementations.

The terms “about,” “approximately,” “generally,” “substantially,” or the like, when used with a number, may mean that specific number, or alternatively, a range in proximity to the specific number, as understood by persons of skill in the art field and may be used to refer to within manufacturing and/or engineering design tolerances for the corresponding materials and/or elements as would be understood by the person of ordinary skill in the art, unless otherwise indicated.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such a component or feature may be optionally included in some embodiments, or it may be excluded.

If the specification presents a list, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

The term “set” refers to a collection of one or more items.

The term “plurality” refers to two or more items.

The term “or” is used herein in both the alternative and conjunctive sense, unless otherwise indicated.

### Example Computer Program Products and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for, or used in addition to, the computer-readable storage media described above.

As should be appreciated, various embodiments of the present disclosure may also be implemented as methods, apparatuses, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises combination of computer program products and hardware performing certain steps or operations. For example, the method, apparatus, and computer program product of an example embodiment may be embodied by a networked device (e.g., an enterprise platform), such as a server or other network entity, configured to communicate with one or more devices, such as one or more client devices. Additionally, or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, or any combination of the aforementioned devices.

As used herein, the description may refer to a server or client device as an example “apparatus.” However, elements of the apparatus described herein may be equally applicable to the claimed system, method, and computer program product. Accordingly, use of any such terms should not be taken to limit the spirit and scope of embodiments of the present disclosure.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### Example Framework and Architectures

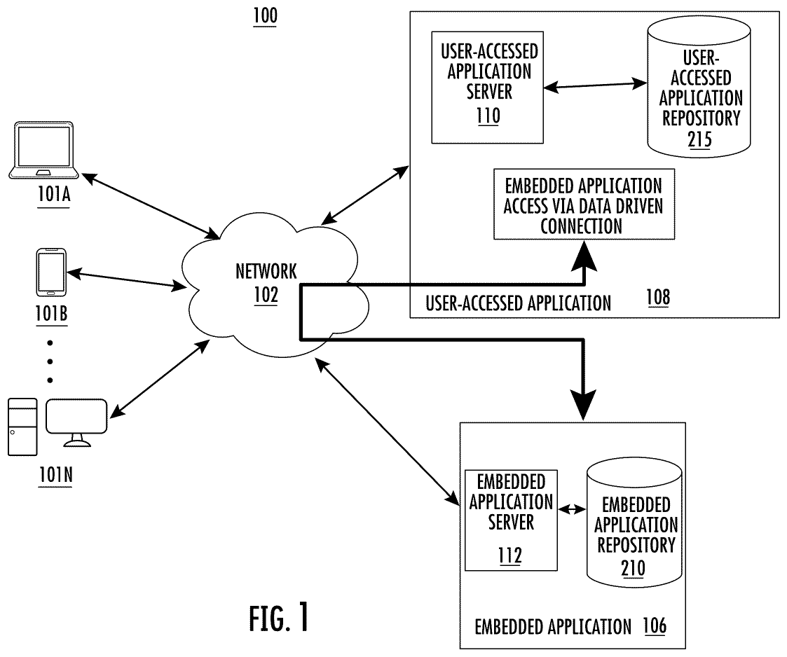

With reference to FIG. 1, an example computing system environment 100 within which some embodiments of the present disclosure operate is illustrated. The example computing system environment 100 comprises a user-accessed application 108, an embedded application 106, and a plurality of client devices 101A-101N, each communicatively connected through a communications network 102. Accordingly, user(s) may access the user-accessed application 108 and/or the embedded application 106 via the communications network 102 using one or more of client devices 101A-101N. For example, the client devices 101A-101N may access the user-accessed application 108 through the communications network 102. The communications network 102 may include any one or more wired and/or wireless communication networks including, for example, a wired or wireless local area network (LAN), personal area network (PAN), metropolitan area network (MAN), wide area network (WAN), or the like, as well as any hardware, software and/or firmware required for implementing the one or more networks (e.g., network routers, switches, hubs, etc.). For example, communications network 102 may include a cellular telephone, mobile broadband, long term evolution (LTE), GSM/EDGE, UMTS/HSPA, IEEE 802.11, IEEE 802.16, IEEE 802.20, Wi-Fi, dial-up, and/or WiMAX network. Furthermore, the communications network 102 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of any example computing system environment in which example embodiments of the present disclosure are used.

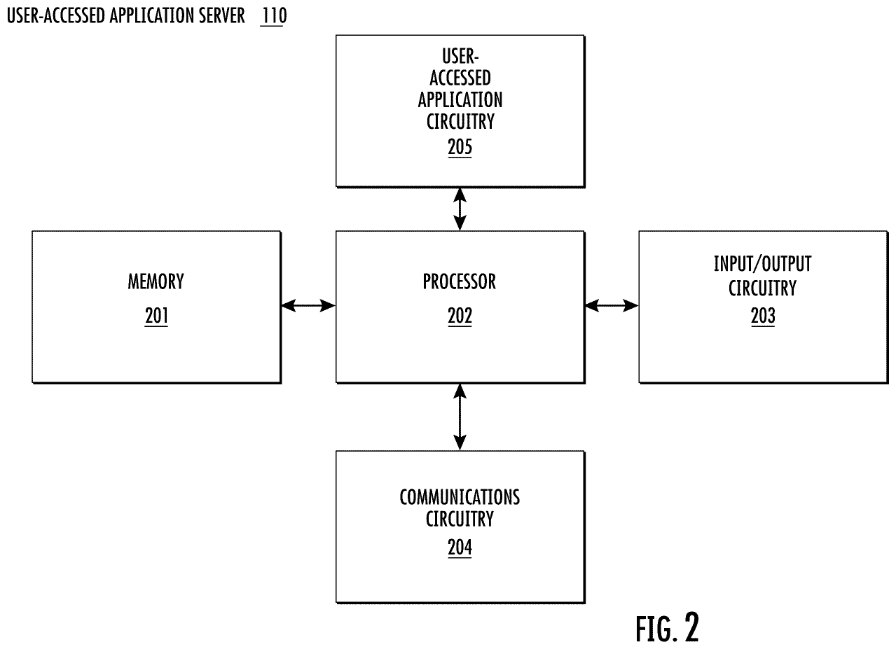

With continued reference to FIG. 1, the user-accessed application 108 may comprise or otherwise operate via a user-accessed application server 110 in communication with at least one data repository, such as the depicted user-accessed application repository 215 for storing and retrieving user-accessed application source data. User-accessed application server 110 may include circuitry, networked processors, or the like configured to perform some or all of the frictionless integrated user interface and user-accessed application-based processes described herein and may be any suitable network server and/or other type of processing device. In some embodiments, user-accessed application server 110 may determine and transmit commands and instructions for outputting a user-accessed application user interface for display in an application display window or otherwise causing transformation of such application display window to define a frictionless integrated user interface for display on client devices 101A-101N, using data from, for example, user-accessed application repository 215 (and/or embedded application repository 220 as received via the data-driven connection as discussed herein). In this regard, user-accessed application server 110 may be embodied by any of a variety of devices, for example, the user-accessed application server 110 may be embodied as a computer or a plurality of computers or computing devices performing interconnected and/or distributed functions. For example, user-accessed application server 110 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least the components illustrated in FIG. 2 and described in connection therewith. Despite the many arrangements contemplated herein, user-accessed application server 110 is shown and described herein as a single computing device to avoid unnecessarily overcomplicating the disclosure.

The user-accessed application repository 215 may be hosted by the user-accessed application server 110 or otherwise hosted by devices in communication with the user-accessed application server 110. That is, in some embodiments, user-accessed application server 110 may be located remotely from the user-accessed application repository 215 and/or the embedded application repository 220, although in other embodiments, the user-accessed application server 110 may comprise at least the user-accessed application repository 215. The user-accessed application repository 215 may connect bidirectionally with the user-accessed application server 110 to enable data storage and retrieval operations.

The user-accessed application repository 215 may be stored by any suitable storage device configured to store some or all of the information described herein (e.g., memory 201 of the user-accessed application server 110 or a separate memory system separate from the user-accessed application server 110, such as one or more database systems, backend data servers, network databases, cloud storage devices, or the like provided by another device (e.g., online application or 3rd party provider), such as a Network Attached Storage (NAS) device or devices, or as a separate database server or servers. The user-accessed application repository 215 may comprise data received from the user-accessed application server 110 (e.g., via a memory 201 and/or processor(s) 202), and the corresponding storage device may thus store this data. The user-accessed application repository 215 includes information accessed and stored by the user-accessed application server 110 to facilitate the operations of the user-accessed application 108. As such, the user-accessed application repository 215 may include, for example, without limitation, data associated with the user-accessed application, such as user-accessed application source data, user-accessed application data objects, executable user-accessed application code base, project identifiers, issue identifiers, user identifiers, and/or the like.

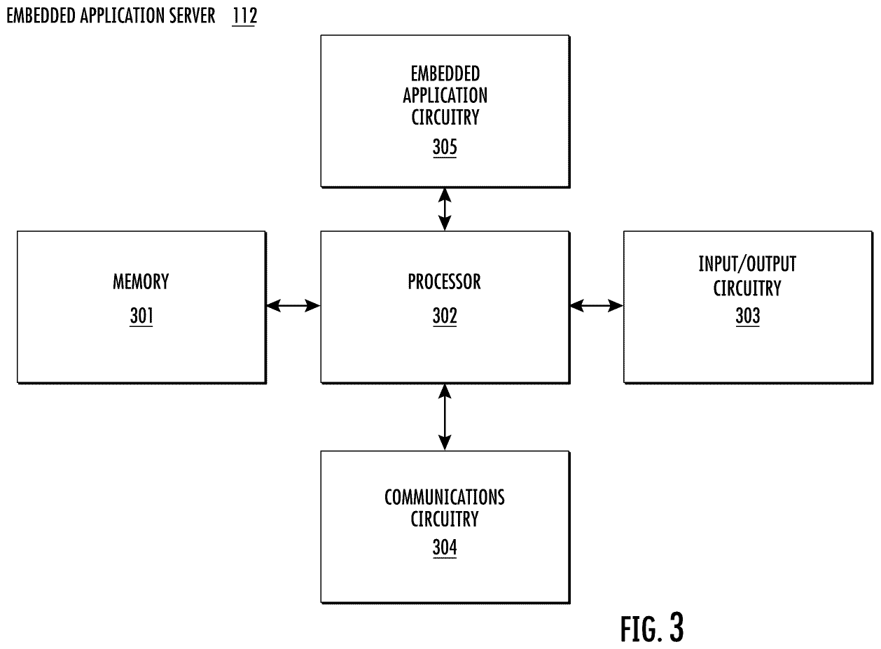

With continued reference to FIG. 1, the embedded application 106 may comprise or otherwise operate via an embedded application server 112 in communication with at least one data repository, such as the depicted embedded application repository 210 for storing and retrieving embedded application source data. Embedded application server 112 may include circuitry, networked processors, or the like configured to perform some or all of the embedded application-based processes described herein and may be any suitable network server and/or other type of processing device. Embedded application server 112 may be embodied by any of a variety of devices, for example, the embedded application server 112 may be embodied as a computer or a plurality of computers or computing devices performing interconnected and/or distributed functions. For example, embedded application server 112 may be configured to receive/transmit data and may include any of a variety of fixed terminals, such as a server, desktop, or kiosk, or it may comprise any of a variety of mobile terminals, such as a portable digital assistant (PDA), mobile telephone, smartphone, laptop computer, tablet computer, or in some embodiments, a peripheral device that connects to one or more fixed or mobile terminals. Example embodiments contemplated herein may have various form factors and designs but will nevertheless include at least the components illustrated in FIG. 3 and described in connection therewith. Despite the many arrangements contemplated herein, embedded application server 112 is shown and described herein as a single computing device to avoid unnecessarily overcomplicating the disclosure.

The embedded application repository 210 may be hosted by the embedded application server 112 or otherwise hosted by devices in communication with the embedded application server 112. That is, in some embodiments, embedded application server 112 may be located remotely from the embedded application repository 210, although in other embodiments, the embedded application server 112 may comprise the embedded application repository 210. The embedded application repository 210 may connect bidirectionally with the embedded application server 112 to enable data storage and retrieval operations.

The embedded application repository 210 may be stored by any suitable storage device configured to store some or all of the information described herein (e.g., memory 301 of the embedded application server 112 or a separate memory system separate from the embedded application server 112, such as one or more database systems, backend data servers, network databases, cloud storage devices, or the like provided by another device (e.g., online application or 3rd party provider), such as a Network Attached Storage (NAS) device or devices, or as a separate database server or servers. The embedded application repository 210 may comprise data received from the embedded application server 112 (e.g., via a memory 301 and/or processor(s) 302), and the corresponding storage device may thus store this data. The embedded application repository 210 includes information accessed and stored by the embedded application server 112 to facilitate the operations of the embedded application 106. As such, the embedded application repository 210 may include, for example, without limitation, data associated with the embedded application, such as embedded application source data, embedded application data objects, executable embedded application code base, project identifiers, issue identifiers, user identifiers, and/or the like.

As depicted in FIG. 1, the embedded application 106 may be accessible via a data-driven connection established between and/or otherwise associated with the user-accessed application 108. This connection may enable interoperability between the user-accessed application 108 and the embedded application 106, allowing functionality from the embedded application 106 to be embedded within and accessible via the user-accessed application 108, while maintaining the context of the user-accessed application 108. In some non-limiting embodiments, a user-accessed application 108 is a software development tool and/or project management tool (e.g., Jira Software®, Jira Services Management®, Jira Work Management®, etc.). In still other non-limiting embodiments, an embedded application 106 is a collaboration tool (e.g., Confluence®).

With continued reference to FIG. 1, the client devices 101A-101N may be implemented as any computing device as defined above. Electronic data from the client devices 101A-101N may be provided in various forms and via various methods. For example, the client devices 101A-101N may include desktop computers, laptop computers, smartphones, netbooks, tablet computers, wearables, and/or other networked device, that may be used for any suitable purpose in addition to presenting the application display window and associated interfaces to a user and otherwise providing access to the user-accessed application 108 and embedded application 106. The depiction in FIG. 1 of “N” client devices is merely for illustration purposes. According to some embodiments, the client devices 101A-101N may be configured to display an interface on a display of the client device for viewing, creating, editing, and/or otherwise interacting with at least one frictionless integrated user interface, updated frictionless integrated user interface, user-accessed user interface, modified user-accessed user interface, embedded application access interface, or the like, which may be provided by the data-driven connection between the embedded application 106 and the user-accessed application 108.

In embodiments where a client device 101A-101N is a mobile device, such as a smartphone or tablet, the client device 101A-101N may execute an “app” to interact with, for example, the user-accessed application 108. Such apps are typically designed to execute on mobile devices, such as tablets or smartphones. For example, an app may be provided that executes on mobile device operating systems such as iOS®, Android®, or Windows®. These platforms typically provide frameworks that allow apps to communicate with one another and with particular hardware and software components of mobile devices. The mobile operating systems named above each provide frameworks for interacting with, for example, wired and wireless network interfaces, user contacts, and other applications. Communication with hardware and software modules executing outside of the app is typically provided via application programming interfaces (APIs) provided by the mobile device operating system. Additionally, or alternatively, the client device 101A-101N may interact with, for example, the user-accessed application 108 via a web browser. As yet another example, the client devices 101A-101N may include various hardware or firmware designed to interface with the user-accessed application 108 and/or embedded application 106.

The computing systems described herein can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

Turning to FIG. 2, a block diagram of an example user-accessed application server 110 in accordance with at least some example embodiments of the present disclosure is illustrated. In accordance with some example embodiments, user-accessed application server 110 may include various components, modules, circuitries, or means, some or all of which may be also or instead be included in one or more client device(s) 101A-101N. In accordance with some example embodiments, user-accessed application server 110 may be configured, using one or more of the sets of circuitry embodying memory 201, processor 202, input/output circuitry 203, communications circuitry 204, and/or user-accessed application circuitry 205 to execute and perform the operations described herein. In some embodiments, user-accessed application circuitry 205 is included in user-accessed application server 110 and/or client device 101A, the circuitry configured to facilitate the functionality discussed herein regarding defining, outputting, modifying, and/or updating user-accessed application user interfaces, frictionless integrated user interfaces, embedded application access user interfaces and/or the like. It will be appreciated that while various references are made herein to a “server” or “servers” such references are not intended to implicate monolithic servers. Rather, as will be apparent to one of ordinary skill in the art in view of this disclosure, the operations and functionality attributed to any disclosed server may be performed in a cloud computing environment and thereby completed by multiple servers.

Although the use of the term “circuitry” as used herein with respect to components 201-205 are described in some cases with respect to functional limitations, it should be understood that the particular implementations necessarily include the use of particular hardware configured to perform the functions associated with the respective circuitry as described herein. It should also be understood that certain of these components 201-205 may include similar or common hardware. For example, two sets of circuitry may both leverage use of the same processor(s), network interface(s), storage medium(s), and/or the like to perform their associated functions, such that duplicate hardware is not required for each set of circuitry. The use of the term “circuitry” with respect to components of the apparatuses described herein should therefore be understood to include particular hardware configured to perform the functions associated with the respective components or particular circuitry as described herein.

The term “circuitry” should also be understood, in some embodiments, to include software for configuring the hardware. For example, in some embodiments, “circuitry” may include processing circuitry, storage media, network interfaces, input/output devices, and the like. In some embodiments, such as in examples where circuitry is included with user-accessed application server 110, other elements of the user-accessed application server 110 may provide or supplement the functionality of particular circuitry. For example, the processor 202 may provide processing functionality, the memory 201 may provide storage functionality, the communications circuitry 204 may provide network interface functionality, and the like.

In some embodiments, the processor 202 (and/or co-processor or any other processing circuitry assisting or otherwise associated with the processor) may be in communication with the memory 201 via a bus for passing information among components of, for example, user accessed application server 110. The memory 201 is non-transitory and may include, for example, one or more volatile and/or non-volatile memories, or some combination thereof. In other words, for example, the memory 201 may be an electronic storage device (e.g., a computer readable storage medium). The memory 201 may be configured to store information, data, content, applications, instructions, or the like, for enabling an apparatus, e.g., user-accessed application server 110, to carry out various functions in accordance with example embodiments of the present disclosure. For example, the memory 201 may store data and instructions used by the user-accessed application server 110 including but not limited to user-accessed application source data, executable user-accessed application code base, and other data necessary for the operation of the user-accessed application 108.

Although illustrated in FIG. 2 as a single memory, memory 201 may comprise a plurality of memory components. The plurality of memory components may be embodied on a single computing device or distributed across a plurality of computing devices. In various embodiments, memory 201 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 201 may be configured to store information, data, applications, instructions, or the like for enabling user-accessed application server 110 to carry out various functions in accordance with example embodiments discussed herein. For example, in at least some embodiments, memory 201 is configured to buffer data for processing by processor 202. Additionally or alternatively, in at least some embodiments, memory 201 is configured to store program instructions for execution by processor 202. Memory 201 may store information in the form of static and/or dynamic information. This stored information may be stored and/or used by user-accessed application server 110 during the course of performing its functionalities.

Processor 202 may be embodied in a number of different ways and may, for example, include one or more processing devices configured to perform independently. Additionally or alternatively, processor 202 may include one or more processors configured in tandem via a bus to enable independent execution of instructions, pipelining, and/or multithreading. Processor 202 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. The use of the term “processing circuitry” may be understood to include a single core processor, a multi-core processor, multiple processors internal to the apparatus, and/or remote or “cloud” processors. Accordingly, although illustrated in FIG. 2 as a single processor, in some embodiments, processor 202 comprises a plurality of processors. The plurality of processors may be embodied on a single computing device or may be distributed across a plurality of such devices collectively configured to function as user-accessed application server 110. The plurality of processors may be in operative communication with each other and may be collectively configured to perform one or more functionalities of user-accessed application server 110 as described herein.

In an example embodiment, processor 202 is configured to execute instructions stored in the memory 201 or otherwise accessible to processor 202. Alternatively or additionally, the processor 202 may be configured to execute hard-coded functionality. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure processor 202 to perform one or more algorithms and/or operations described herein when the instructions are executed. For example, these instructions, when executed by processor 202, may cause user-accessed application server 110 to perform one or more of the functionalities of user-accessed application 108 as described herein.

In some embodiments, input/output circuitry 203 may, in turn, be in communication with processor 202 to provide an audible, visual, mechanical, or other output and/or, in some embodiments, to receive an indication of an input. In that sense, input/output circuitry 203 may include means for performing analog-to-digital and/or digital-to-analog data conversions. Input/output circuitry 203 may include support, for example, for a display, touchscreen, keyboard, button, click wheel, mouse, joystick, an image capturing device (e.g., a camera), motion sensor (e.g., accelerometer and/or gyroscope), microphone, audio recorder, speaker, biometric scanner, and/or other input/output mechanisms. Input/output circuitry 203 may comprise a user interface and may comprise a web user interface, a mobile application, a kiosk, or the like. The processor 202 and/or user interface circuitry comprising the processor 202 may be configured to control one or more functions of a display or one or more user interface elements through computer program instructions (e.g., software and/or firmware) stored on a memory accessible to the processor 202 (e.g., memory 201, and/or the like). In some embodiments, aspects of input/output circuitry 203 may be reduced when implemented also or instead as an end-user machine or other type of device designed for complex user interactions (i.e., client device 101). In some embodiments (like other components discussed herein), input/output circuitry 203 may even be eliminated from user-accessed application server 110. Alternatively, in some embodiments, at least some aspects of input/output circuitry 203 may be embodied on an apparatus used by a user (e.g., project team member, project team leader, and/or the like) that is in communication with user-accessed application server 110. Input/output circuitry 203 may be in communication with memory 201, communications circuitry 204, and/or any other component(s), such as via a bus. Although more than one input/output circuitry and/or other component can be included in user-accessed application server 110, only one is shown in FIG. 2 to avoid overcomplicating the disclosure (e.g., like the other components discussed herein).

Communications circuitry 204 may be any means such as a device or circuitry embodied in either hardware or a combination of hardware and software that is configured to receive and/or transmit data from/to a network and/or any other device, circuitry, or module in communication with user-accessed application server 110. In this regard, the communications circuitry 204 may include, for example, a network interface for enabling communications with a wired or wireless communication network. Communications circuitry 204 may be configured to receive and/or transmit any data that may be stored by memory 201 using any protocol that may be used for communications between computing devices. For example, the communications circuitry 204 may include one or more network interface cards, antennae, transmitters, receivers, buses, switches, routers, modems, and supporting hardware and/or software, and/or firmware/software, or any other device suitable for enabling communications via a network. Additionally, or alternatively, the communication interface may include the circuitry for interacting with the antenna(s) to cause transmission of signals via the antenna(s) or to handle receipt of signals received via the antenna(s). These signals may be transmitted by the user-accessed application server 110 using any of a number of wireless personal area network (PAN) technologies, such as Bluetooth® v1.0 through v3.0, Bluetooth Low Energy (BLE), infrared wireless (e.g., IrDA), ultra-wideband (UWB), induction wireless transmission, or the like. In addition, it should be understood that these signals may be transmitted using Wi-Fi, Near Field Communications (NFC), Worldwide Interoperability for Microwave Access (WiMAX) or other proximity-based communications protocols. Communications circuitry 204 may additionally or alternatively be in communication with the memory 201, input/output circuitry 203 and/or any other component of user-accessed application server 110, such as via a bus.

In some embodiments, user-accessed application circuitry 205 may also or instead be included and configured to perform the functionality discussed herein related to defining, outputting, modifying and/or updating frictionless integrated user interfaces, user-accessed application user interfaces, and embedded application access interfaces, and/or other specific functionality related to the user-accessed application operations of the user-accessed application server 110. In some cases, the user-accessed application circuitry 205 may process requests from the client devices 101A-101N, interact with the user-accessed application repository 215, and manage the data-driven connection with the embedded application 106.

User-accessed application circuitry 205 includes hardware components and/or software configured to support interface functionality, features, and/or services of the user-accessed application server 110 and/or client device 101A. The user-accessed application circuitry 205 may utilize processing circuitry, such as the processor 202, to perform its corresponding operations, and may utilize memory 201 to store collected information. The user-accessed application circuitry 205 may send and/or receive data from user-accessed application repository 215 and/or embedded application 106 (e.g., embedded application server 112). In some implementations, the sent and/or received data may include identifier(s) (e.g., project identifier, issue identifier, team identifier, team member identifier, and/or the like), and associated data that is configured for association with, for example, defining, outputting, modifying and/or updating frictionless integrated user interfaces, user-accessed application user interfaces, embedded application access interfaces, and/or the like.

It should also be appreciated that, in some embodiments, the user-accessed application circuitry 205 may include a separate processor, specially configured field programmable gate array (FPGA), or application specific interface circuit (ASIC) to perform its corresponding functions. For example, in some embodiments, some or all of the functionality of user-accessed application circuitry 205 may be performed by processor 202. In this regard, some or all of the example processes and algorithms discussed herein can be performed by at least one processor 202 and/or user-accessed application circuitry 205. For example, non-transitory computer readable storage media can be configured to store firmware, one or more application programs, and/or other software, which include instructions and other computer-readable program code portions that can be executed to control processors of the components of user-accessed application server 110 to implement various operations, including the examples shown herein. As such, a series of computer-readable program code portions may be embodied in one or more computer program products and can be used, with a device, user-accessed application server 110, database, and/or other programmable apparatus, to produce the machine-implemented processes discussed herein. It is also noted that all or some of the information discussed herein can be based on data that is received, generated and/or maintained by one or more components of the user-accessed application server 110, client device 101A, etc. In some embodiments, one or more external systems (such as a remote cloud computing and/or data storage system) may also be leveraged to provide at least some of the functionality discussed herein.

The various components of the user-accessed application server 110 depicted in FIG. 2 may work together to provide the functionality of the user-accessed application 108. For example, when a request is received from a client device 101A-101N, the communications circuitry 204 may receive the request and pass it to the processor 202. The processor 202 may then use the user-accessed application circuitry 205 to process the request, which may involve retrieving data from the memory 201, the user-accessed application repository 215, and/or the embedded application 106 via a data-driven connection as described herein and using such data to cause transformation of an application display window to define and populate a frictionless integrated user interface with a modified user-accessed application user interface positioned proximate an embedded application access interface within the application display window. The processed result may then be sent back to the client device 101A-101N via the input/output circuitry 203 and the communications circuitry 204, enabling users to interact with the embedded application 106 through the user-accessed application 108 and otherwise update user-accessed application source data based on user interaction with the modified user-accessed application user interface, and the embedded application source data based on user interaction with the embedded application access interface.

FIG. 3 illustrates a block diagram of an example embedded application server 112 in accordance with at least some example embodiments of the present disclosure is illustrated. In accordance with some example embodiments, embedded application server 112 may be configured, using one or more of the sets of circuitry embodying memory 301, processor 302, input/output circuitry 303, communications circuitry 304, and/or embedded application circuitry 305 to execute and perform the operations and functionality of the embedded application 106 as described herein. The circuitry 301-305 may function similarly or identically to the similarly named components depicted and described with respect to the user-accessed application server 110 in FIG. 2, the 301-305 components being interconnected and configured to work together to provide the functionality of the embedded application server 112. For purposes of brevity and length of disclosure, repeated disclosure with regard to the functionality of such similarly named sets of circuitry is omitted herein.

The memory 301 of the embedded application server 112 may be configured to store data, instructions, and other information used by the embedded application server 112. In some cases, the memory 301 may store embedded application source data, executable embedded application code base, and other data necessary for the operation of the embedded application 106. The processor 302 of the embedded application server 112 may be configured to execute instructions and process data to perform various operations of the embedded application 106. The input/output circuitry 303 of the embedded application server 112 may be configured to handle input and output operations for the embedded application server 112. For example, in some cases, the input/output circuitry 303 may facilitate communication between the embedded application server 112 and other devices or systems, such as the user-accessed application server 110. The embedded application circuitry 305 of the embedded application server 112 may be configured to perform specific functionality related to the embedded application 106. For example, in some cases, the embedded application circuitry 305 may process requests from the user-accessed application 108 (e.g., via the user-accessed application server 110), interact with the embedded application repository 210, and manage the data and operations specific to the embedded application 106.

The various components of the embedded application server 112 may work together to provide the functionality of the embedded application 106. For example, when a request is received from the user-accessed application 108 via the data-driven connection, the communications circuitry 304 may receive the request and pass the request to the processor 302. The processor 302 may then use the embedded application circuitry 305 to process the request, which may involve retrieving data from the memory 301 or the embedded application repository 210. For example, in some cases, the embedded application server 112 may communicate with the embedded application repository 210 to store and retrieve embedded application source data. The processed result may then be sent back to the user-accessed application 108 via the communications circuitry 304, the user-accessed application 108 configured to use such data to define and populate the embedded application access interface within the frictionless integrated user interface, enabling users to interact with the embedded application 106 through the user-accessed application 108 and otherwise update the embedded application source data based on user interaction with the embedded application access interface.

### Example User Interfaces

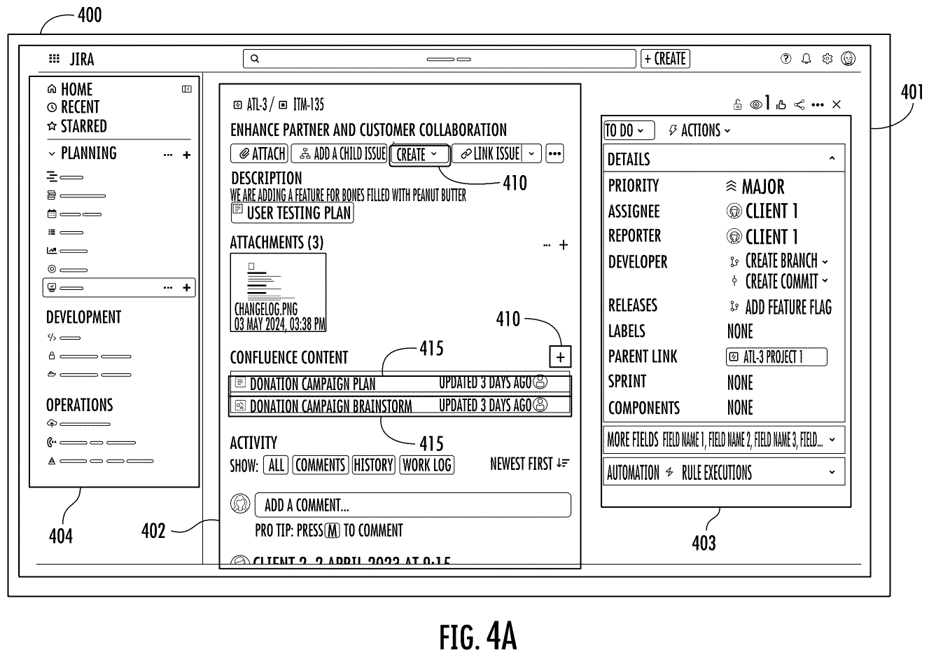

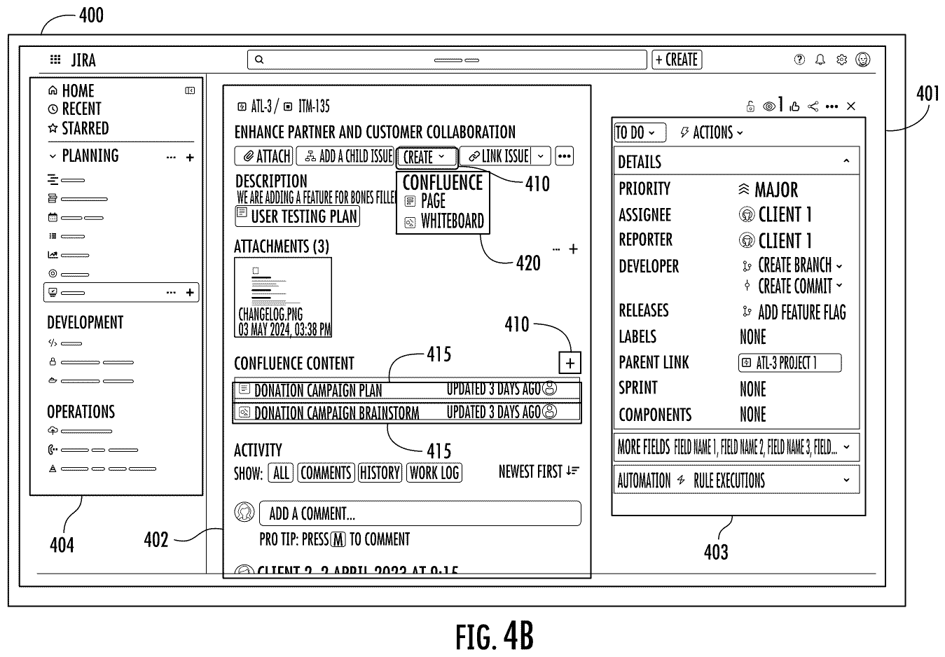

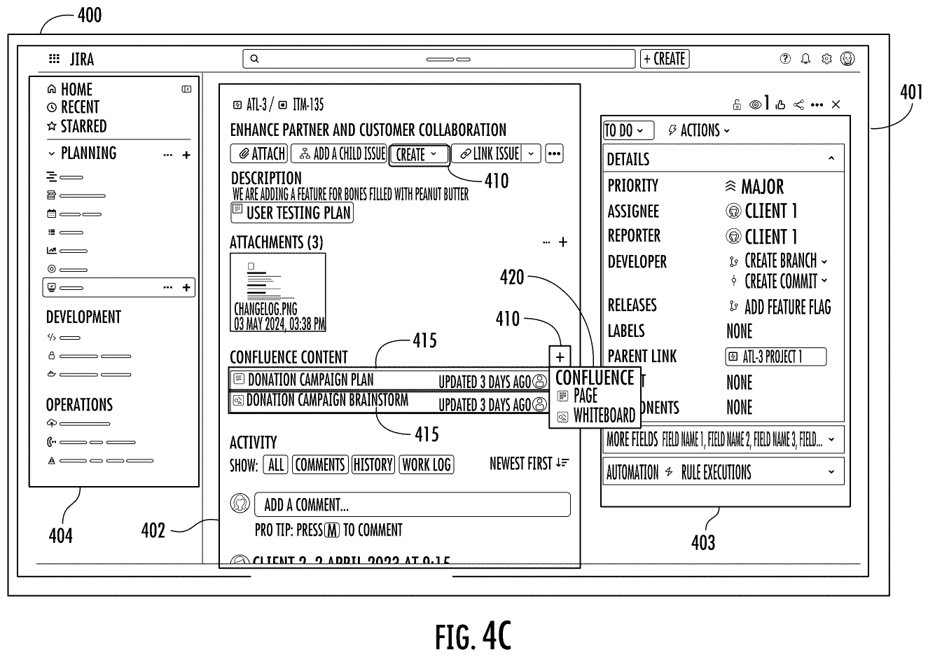

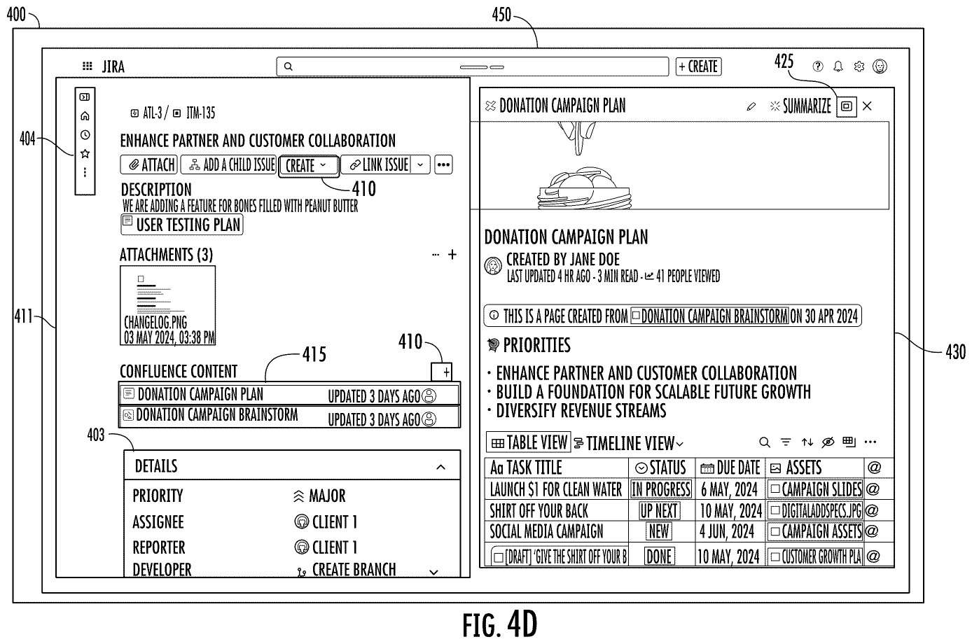

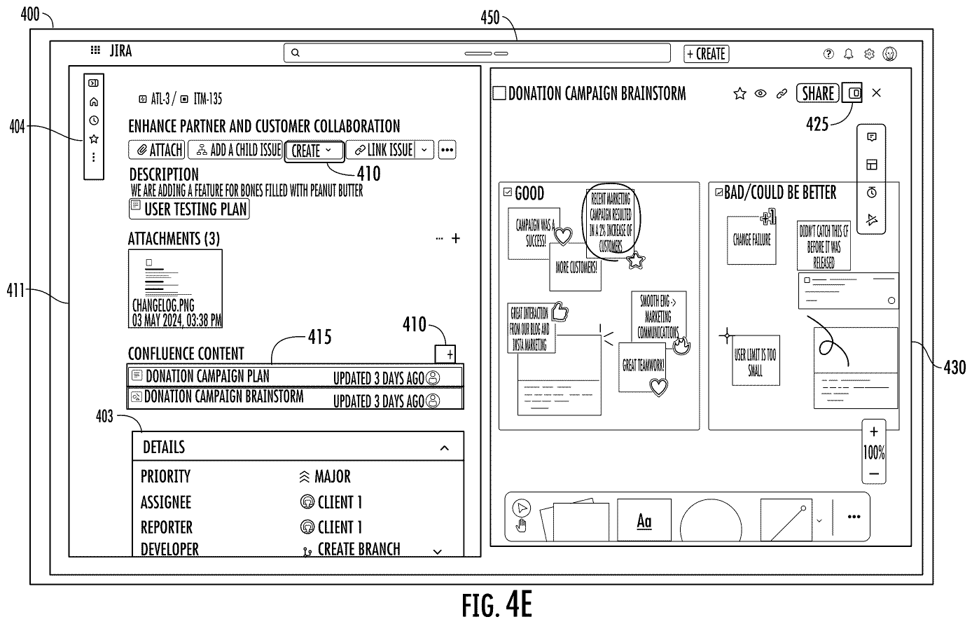

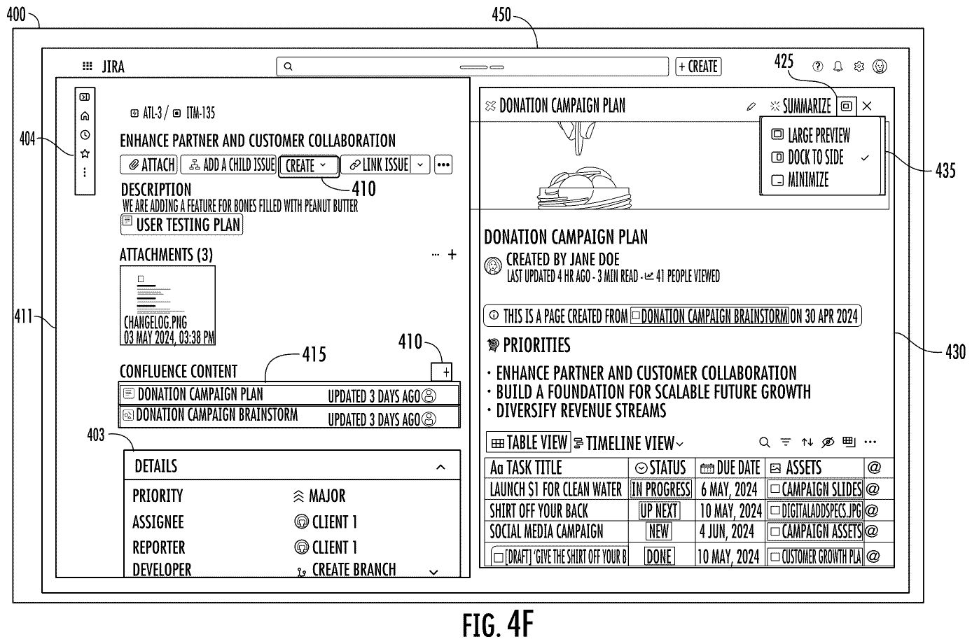

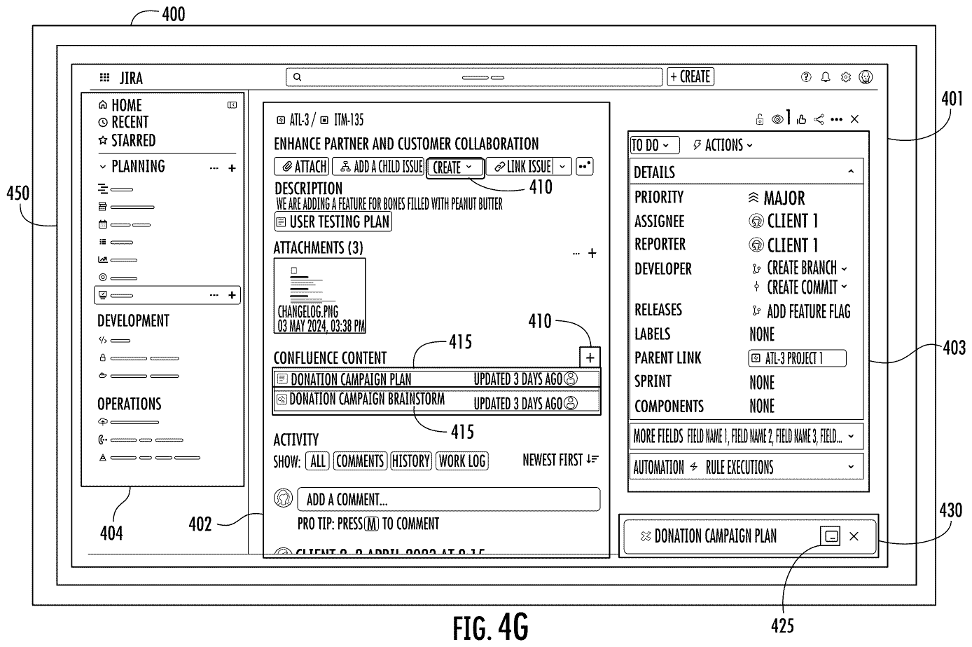

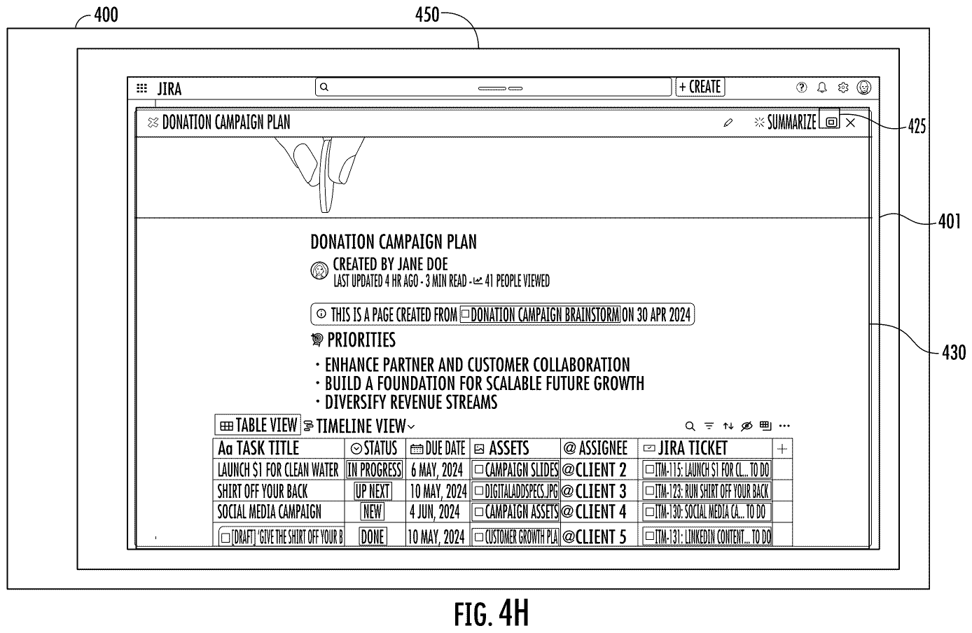

In various embodiments of the present disclosure, user-accessed application 108 may be configured (e.g., via user-accessed application server 110) to define, output, modify, and/or update a variety of user interfaces to an application display window and otherwise transform the application display window as described herein. For example, in some cases, a user-accessed application user interface 401 may be outputted to a client device (e.g., client device 101A) to be displayed within an application display window 400, as depicted in FIGS. 4A, 4B, and 4C. In some non-limiting examples wherein the user-accessed application comprises a project management application and the embedded application comprises a collaboration application, the user-accessed application user interface 401 may comprise a full-screen issue view for the project management application. Such a full-screen issue view may provide a comprehensive display of information and interactive elements related to a specific issue or task within the project management application.

As shown in FIG. 4A, the user-accessed application user interface 401 may include an issue description panel 402. The issue description panel 402 may contain detailed information about a particular issue, such as a description, comments, attachments, and sub-tasks. In some cases, the issue description panel 402 may serve as the primary interface for users to interact with and/or update the content of an issue.

In some embodiments, the user-accessed application user interface 401 may comprise an issue context panel 403. For example, as illustrated in FIGS. 4A, 4B, and 4C, an issue context panel 403 may be positioned adjacent to the issue description panel 402. The issue context panel 403 may provide contextual information about the issue, such as the assignee, status, and other relevant metadata as depicted in FIGS. 4A, 4B, and 4C.

With continued reference to FIGS. 4A, 4B, and 4C, a navigation panel 404 may be located along one edge of the user-accessed application user interface 401. The navigation panel 404 may be configured to allow users to navigate between different sections and views within the project management application.

The user-accessed application user interface 401 may also include one or more engagement components that enable access to the functionality of and user interaction with an embedded application (e.g., a collaboration application) via a contextual embedded application access request. For example, as shown in FIGS. 4A, 4B, and 4C, the user-accessed application user interface 401 may contain one or more create embedded application content engagement components 410 and one or more access linked embedded application content engagement components 415.

In some cases, user interaction with a create embedded application content engagement component 410 may generate a create embedded application content request. This request may be an example of a contextual embedded application access request. Similarly, user interaction with an access linked embedded application content engagement component 415 may generate an access linked embedded application content request, which may be another example of a contextual embedded application access request.

FIG. 4B illustrates an example user-accessed application user interface 401 after a user has interacted with one of the create embedded application content engagement components 410 depicted in FIG. 4A. For example, in response to such user interaction, an embedded application content creation menu engagement component 420 may be displayed. The embedded application content creation menu engagement component 420 may include options for creating new content within the embedded application, such as a new page or whiteboard, as depicted in FIG. 4B.

FIG. 4C depicts another example user-accessed application user interface 401 after user interaction with a create embedded application content engagement component 410. Similar to FIG. 4B, an embedded application content creation menu engagement component 420 may be displayed, providing options for creating new content within the embedded application. The arrangement and functionality of these components within the user-accessed application user interface 401 may enable seamless interaction between the user-accessed application (e.g., project management application) and the embedded application (e.g., collaboration application), allowing users to access, create, manage, update, and otherwise interact with content across both applications within a single application display window as set forth in FIGS. 4D-4H.

Turning to FIGS. 4D, 4E, and 4F, in some cases, a frictionless integrated user interface 450 may be defined and outputted for display within the application display window 400. For example, a frictionless integrated user interface 450 may be defined in response to receiving a contextual embedded application access request. For example, the contextual embedded application access request may be received in response to user interaction with an embedded application engagement component, such as the access linked embedded application content engagement component 415 or create embedded application content engagement component 410 and subsequent user interaction with one of the options for creating new content within the embedded application displayed in the embedded application content creation menu engagement component 420 (e.g., a new page or whiteboard) as described herein with respect to FIGS. 4B and 4C.

In some embodiments, the frictionless integrated user interface 450 may include a modified user-accessed application user interface 411 positioned proximate an embedded application access interface 430 within the application display window 400. In some cases, the frictionless integrated user interface 450 may be defined with a side-by-side view of the modified user-accessed application user interface 411 and the embedded application access interface 430, as depicted in the example embodiments of FIGS. 4D, 4E, and 4F. The frictionless integrated user interface 450 may be configured to enable updating of the user-accessed application source data based on user interaction with the modified user-accessed application user interface 411 and the embedded application source data based on user interaction with the embedded application access interface 430 in accordance with example embodiments of the present disclosure as described herein. This configuration may allow users to seamlessly access and utilize the functionality of both applications within a unified interface.

In some embodiments, as depicted in FIGS. 4D, 4E, and 4F, the modified user-accessed application user interface 411 may continue to include essential information, components, and/or panels of the original user-accessed application user interface. For example, the example modified user-accessed application user interfaces 411 depicted in FIGS. 4D, 4E, and 4F include an issue description panel, including such information as the issue title and other essential information. Such essential information, components, and/or panels may be adjusted or relocated to define the frictionless integrated user interface 450. For example, in some cases, a frictionless integrated user interface 450 may be implemented in an instance wherein the original user-accessed application user interface 401 is a full-screen issue view of a project management application (e.g., a user-accessed application), such as depicted in FIGS. 4A, 4B, and 4C. In such example, a modified user-accessed application user interface 411 may retain key elements of such full-screen issue view, such as the information of the issue description panel and (relocated) issue context panel 403, while the frictionless integrated user interface 450 provides access to the embedded application functionality through the embedded application access interface 430.

In some embodiments, as depicted in FIGS. 4D, 4E, and 4F, the modified user-accessed application user interface 411 may include a collapsed or reduced navigation panel 404 (e.g. as compared to the originally displayed user-accessed user interface as depicted in, for example, FIG. 4A) positioned along one side. Although not depicted, the navigation panel 404 may be deleted or otherwise removed from a modified user-accessed application user interface 411.

As depicted in FIGS. 4D, 4E, and 4F, in some embodiments, the issue context panel 403 may be relocated within or removed from the modified user-accessed application user interface 411 as compared to the originally displayed user-accessed user interface when defining the frictionless integrated user interface 450 in order to accommodate the embedded application access interface 430. For example, the issue context panel 403 has been relocated from a right side panel component of the user-accessed application user interface to a vertically-oriented lower portion of the modified user-accessed application user interface 411 of positioned in a left side panel component of the frictionless integrated user interface 450. For example, in some embodiments, the modified user-accessed application user interface 411 may be defined as a first side panel component and the embedded application access interface 430 may be defined as a second side panel component, such as the left side panel component and right side component, respectively, as depicted in FIGS. 4D, 4E, and 4F. Although the frictionless integrated user interface 450 is depicted with the modified user-accessed application user interface 411 on the left and the embedded application access interface 430 on the right in approximately equal proportions, one of ordinary skill in the art would understand and this disclosure contemplates other arrangements and configurations, such as but not limited to the modified user-accessed application user interface 411 on the right and the embedded application access interface 430 on the left in approximately equal or other varying proportions. The embedded application access interface 430 of the frictionless integrated user interface 450 provides access to embedded application features and content while maintaining visibility of and access to the modified user-accessed application user interface 411.

The frictionless integrated user interface 450 may include a resizable boundary between the modified user-accessed application user interface 411 and the embedded application access interface 430. This resizable boundary may allow for adjustment of the relative sizes of the two interfaces within the application display window 400. For example, in some embodiments, an embedded application access interface control engagement component 425 may be provided by the frictionless integrated user interface 450 as part of the embedded application access interface 430. An embedded application access interface control engagement component 425 may provide interactive controls for managing the display of the embedded application access interface 430 relative to the modified user-accessed application user interface 411 (or user-accessed application user interface 401). For example, as shown in FIG. 4F, user interaction with the embedded application access interface control engagement component 425 may instantiate or otherwise provide access to an embedded application access interface control menu 435 with various controls for managing the embedded application interface display.

Although not depicted, in some embodiments, the layout of the modified user-accessed application user interface and the embedded application access interface may be automatically adjusted based at least in part on an application display window width in pixels. This automatic adjustment may ensure optimal use of screen real estate and maintain the context and access to functionality of both applications across different display sizes and configurations. For example, in a non-limiting example, a frictionless integrated user interface may define the modified user-accessed application user interface with a collapsed or reduced navigation panel, a first vertical panel comprising an issue description panel, and a second vertical panel comprising an issue details panel (e.g., or any other types of panels, such as a help panel or comments panel) and further define the embedded application access interface as a third vertical panel in an instance wherein the application display window width satisfies an application display window width threshold (e.g., such as more than 2000 pixels). Such an implementation may use one or more additional interface components to effectively utilize available screen real estate. In another non-limiting example, a frictionless integrated user interface may define the modified user-accessed application user interface with a collapsed or reduced navigation panel in a first vertical panel comprising the information from the issue description panel with additional information from the issue details panel pushed below such issue description information and further define the embedded application access interface as a second vertical panel in an instance wherein the application display window width satisfies an application display window width threshold range (e.g., such as more than 1024 pixels but less than 2000 pixels). This is similar to the embodiments of the frictionless integrated user interface 450 depicted in FIGS. 4D, 4E, and 4F. In still another non-limiting example, a frictionless integrated user interface may define the embedded application access interface as a nearly full-screen modal overlay to the user-accessed application user interface in an instance wherein the application display window width fails to satisfy an application display window width threshold (e.g., such as less than 1024 pixels). This is similar to the embodiment of the frictionless integrated user interface 450 depicted in FIG. 4H.

By causing transformation of the application display window 400 to define the frictionless integrated user interface 450, the user-accessed application 108 may enable users to reference and edit information across both the user-accessed application 108 and the embedded application 106 while maintaining visibility of relevant content without manually switching between separate application display windows. The programmatic side-by-side arrangement of the modified user-accessed application user interface 411 and the embedded application access interface 430 may facilitate concurrent access to functionality from both applications, such as enabling updating of the user-accessed application source data based on user interaction with the modified user-accessed application user interface and the embedded application source data based on user interaction with the embedded application access interface.

Turning to FIGS. 4G and 4H, in some cases, a frictionless integrated user interface 450 may be configured to display the embedded application access interface 430 in different states, such as a minimized state or an expanded state. These different states may affect the overall layout and functionality of the frictionless integrated user interface 450. With reference to FIG. 4G, an example frictionless integrated user interface 450 with the embedded application access interface 430 in a minimized state is illustrated. In this configuration, the embedded application access interface 430 may be displayed as a small component, such as a button or icon, typically positioned in a corner of the application display window 400. The minimized state of the embedded application access interface 430 allows the modified user-accessed application user interface 411 to revert to the user-accessed user interface which occupies a larger portion of the frictionless integrated user interface 450 displayed in the application display window 400, providing more space for viewing and interacting with the user-accessed application content when necessary while still providing ease of access to the embedded application content via interaction with the minimized embedded application access interface 430. That is, the embedded application access interface 430 may be minimized to a docked state without closing it. This docked state may allow users to quickly access the embedded application functionality when needed (e.g., by interacting with embedded application access interface control engagement component 425), while maximizing the available space for the user-accessed application user interface 401 in the frictionless integrated user interface 450. The docked state may be particularly useful when users need to focus on the user-accessed application content but want to maintain easy access to the embedded application features.

With reference to FIG. 4H, an example frictionless integrated user interface 450 with the embedded application access interface 430 in an expanded state is illustrated. In this configuration, the embedded application access interface 430 may occupy a larger portion of the application display window 400, potentially overlaying part or all of the user-accessed application user interface 401. The expanded state provides users with a more comprehensive view of the embedded application content and functionality when necessary while still providing ease of access to the user-accessed application content via interaction with the embedded application access interface control engagement component 425. Upon receiving this request, the user-accessed application 108 may cause transformation of the application display window 400 to define an updated frictionless integrated user interface 450 in accordance with the requested state of the embedded application access interface. This transformation may involve adjusting the resizable boundary between the modified user-accessed application user interface 411 (or user-accessed application user interface 401) and the embedded application access interface 430 to decrease the size of the embedded application access interface 430, such as minimizing the embedded application access interface or docking the embedded application access interface to a side panel as described in various examples herein. The ability to switch between minimized and expanded states of the embedded application access interface 430 within the frictionless integrated user interface 450 may provide users with flexibility in managing their workspace. Users may seamlessly transition between focusing on the user-accessed application content and accessing the embedded application functionality, all within a single application display window 400.

In some embodiments, the embedded application access interface 430 may be configured to maintain its scroll position when maximized or docked to a side panel after being minimized or even closed. This feature may help users maintain their context and workflow when switching between the various minimized, docked side panel, and expanded states of the embedded application access interface 430, as well as after closing the embedded application access interface 430. In certain embodiments, when a user attempts to close or navigate away from the embedded application access interface 430 while in edit mode, the user-accessed application 108 may be configured to prompt the user to save changes. This feature may help prevent accidental loss of unsaved work and improve the overall user experience. The embedded application access interface 430 may also be configured to be anchored or pinned to persist across multiple issues in the user-accessed application 108. This functionality may allow users to maintain access to relevant embedded application content while navigating through different issues or tasks within the user-accessed application 108.

Such depicted examples of frictionless integrated user interfaces, user-accessed application user interfaces, embedded application access interfaces, engagement components, panels, actuator buttons, layouts, and/or the like are for purposes of illustration and not of limitation and other suitable variations of depicting the various interfaces, engagement components, panels, layouts, and the like are also contemplated by this disclosure as will be apparent to one of ordinary skill in the art.

### Example Operations Performed

Having described example system architectures, apparatuses, exemplary circuitry, and user interfaces in accordance with various embodiments of the present disclosure, example processes of the disclosure will now be discussed. It will be appreciated that each of the flowcharts depicts an example computer-implemented process that is performable by one or more of the apparatuses, systems, devices, and/or computer program products described herein, for example utilizing one or more of the specially configured components thereof. It will further be appreciated that the example apparatuses, systems, devices, and/or computer program products may proceed to define, output, modify, transform, and/or update frictionless integrated user interfaces, user-accessed application user interfaces, and embedded application access interfaces for display within an application display window in a number of different ways.

The steps or blocks indicate operations of each process. Such operations may be performed in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally, or alternatively, any of the processes in various embodiments include some or all operational steps described and/or depicted, including one or more optional blocks in some embodiments. With regard to the flowcharts illustrated herein, one or more of the depicted block(s) in some embodiments is/are optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

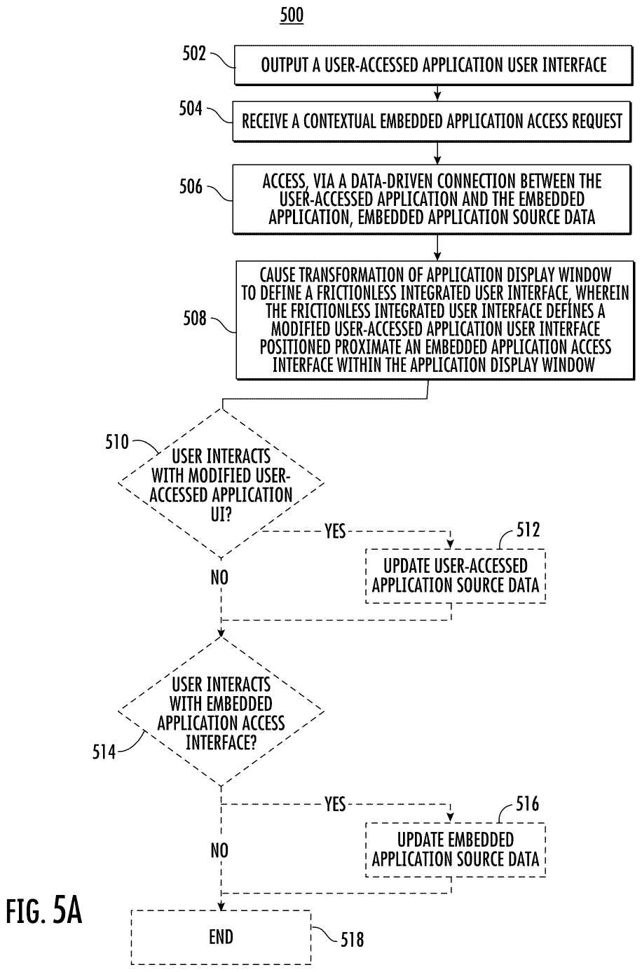

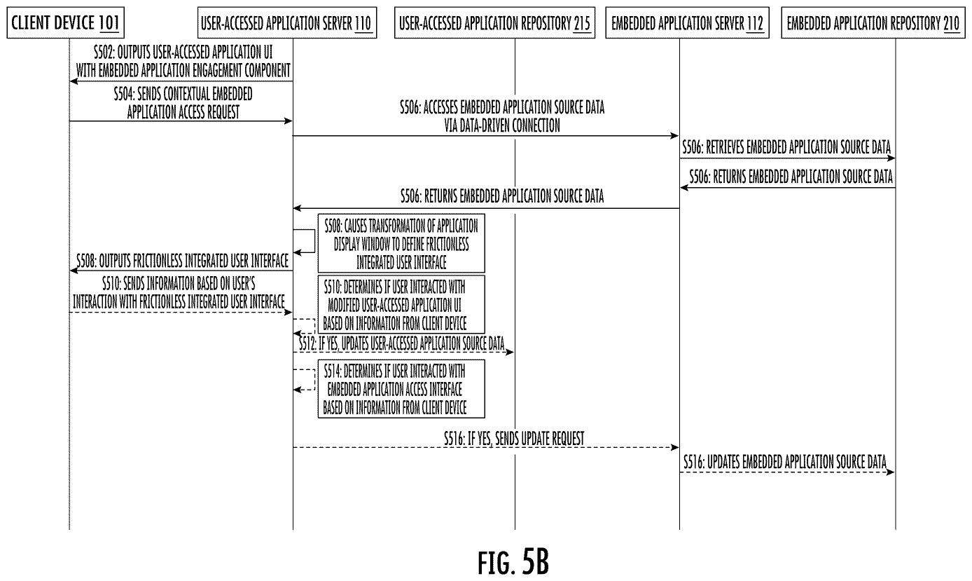

FIG. 5A is a flowchart broadly illustrating a series of operations, steps, or process blocks that are executed or performed to define a frictionless integrated user interface for rendering in association with a user-accessed application and an embedded application in accordance with some example embodiments of the present disclosure. In some embodiments, the method 500 is embodied by computer program code stored on a non-transitory computer-readable storage medium of a computer program product configured for execution to perform the process as depicted and described. In this regard, in some such embodiments, the user-accessed application server 110 is specially configured by computer-coded instructions (e.g., computer program instructions) stored thereon, for example in the memory 201 and/or another component depicted and/or described herein and/or otherwise accessible to the user-accessed application server 110, for performing the operations as depicted and described. Alternatively, or additionally, in some embodiments, the method 500 is performed by one or more specially configured computing devices, such as the user-accessed application server 110 alone or in communication with one or more other component(s), device(s), system(s), and/or the like. For example, the method 500 may be implemented by the user-accessed application 108 and/or the user-accessed application server 110 in communication with the embedded application 106 and/or the embedded application server 112. For purposes of simplifying the description, the method 500 is described as performed by and from the perspective of the user-accessed application server 110. In this regard, performance of the operations may invoke one or more of memory 201, processor 202, input/output circuitry 203, communications circuitry 204, and/or user-accessed application circuitry 205.

In the embodiment illustrated in FIG. 5A, the flowchart illustrates method 500 which begins at step 502 with outputting a user-accessed application user interface for display within an application display window. For example, the user-accessed application server 110 may include means, such as the processor 202, communications circuitry 204, user-accessed application circuitry 205, or the like, for outputting the user-accessed application user interface. In some cases, the user-accessed application user interface may be configured to access and display user-accessed application source data supported by a first executable user-accessed application code base and the user-accessed application user interface may comprise an embedded application engagement component as depicted in the example user-accessed application user interfaces illustrated in FIGS. 4A, 4B, and 4C.

At step 504, the method 500 may involve receiving a contextual embedded application access request. For example, such request may be generated in response to user interaction with the embedded application engagement component of the user-accessed application user interface displayed to the application display window at the client device. In some embodiments, the contextual embedded application access request may correspond to an embedded application supported by a second executable embedded application code base.

The method 500 may proceed to step 506, where embedded application source data may be accessed via a data-driven connection between the user-accessed application and the embedded application based on the contextual embedded application access request received in step 504. For example, the user-accessed application server may communicate with the embedded application server via the data-driven connection and the embedded application server may communicate or otherwise interact with the embedded application repository as described herein.

At step 508, the method 500 may involve causing transformation of the application display window to define a frictionless integrated user interface. In some cases, the frictionless integrated user interface may define a modified user-accessed application user interface positioned proximate an embedded application access interface within the application display window. The frictionless integrated user interface may be configured to enable updating of the user-accessed application source data based on user interaction with the modified user-accessed application user interface and the embedded application source data based on user interaction with the embedded application access interface.

The method 500 may then move to an optional decision step 510, where a determination may be made whether a user has interacted with the modified user-accessed application user interface. If yes, the method 500 may proceed to step 512 where the user-accessed application server 110 updates the user-accessed application source data in the user-accessed application repository 215. If no, the method 500 may proceed to optional decision step 514.

At optional decision step 514, the method 500 may determine whether a user has interacted with the embedded application access interface of the frictionless integrated user interface. If yes, the method 500 may proceed to step 516 where the embedded application source data may be updated. For example, the user-accessed application server 110 may communicate with the embedded application server 112 to update the embedded application source data in the embedded application repository 210. If no, the method 500 may proceed to step 518. Optional steps 510-516 may be repeated any number of times to address potential user interactions with the frictionless integrated user interface before proceeding to step 518. In still other embodiments, the method 500 may optionally proceed to optional decision step 514 instead of or concurrently with optional decision step 510.

FIG. 5B is a signal diagram of an example data flow represented by method 500. That is, FIG. 5B illustrates an example signal diagram illustrating data flow interactions between a client device, a user-accessed application server, a user-accessed application repository, an embedded application server, and an embedded application repository when defining a frictionless integrated user interface for rendering in association with a user-accessed application and an embedded application in accordance with some example embodiments of the present disclosure. Method 500 is described as being performed by a client device 101, a user-accessed application server 110, a user-accessed application repository 215, an embedded application server 112, and an embedded application repository 210. These may be similar to those previously discussed with regards to FIG. 1.

The sequence of the signal diagram may begin when a user-accessed application server 110 outputs and a client device 101 receives a user-accessed application user interface (S502). The client device 101 may then send and the user-accessed application server 110 may receive a contextual embedded application access request (S504). Upon receiving this request, the user-accessed application server 110 may access embedded application source data via a data-driven connection by reaching out to the embedded application server 112 (S506). The embedded application server 112 may then retrieve embedded application source data from the embedded application repository 210 (S506), which may return the data back through the chain (S506).

Once the embedded application source data is returned to the user-accessed application server 110, the user-accessed application server 110 may cause transformation of the application display window to define the frictionless integrated user interface, the frictionless integrated user interface defining a modified user-accessed application user interface positioned proximate an embedded application access interface within the application display window (S508). Causing transformation of the application display window may include the user-accessed application server 110 outputting this frictionless integrated user interface to the client device 101 (S508).

Subsequent to transformation of the application display window, the client device 101 may optionally send information based on user interaction with the frictionless integrated user interface to the user-accessed application server 110 (optional S510). The user-accessed application server 110 may optionally determine if the user interacted with the modified user-accessed application user interface based on the received user interaction information (optional S510) and, if yes, the user-accessed application server 110 may update the user-accessed application source data in accordance with such user interaction by communicating with the user-accessed application repository 215 (optional S512).

Based on the user interaction information received from the client device 101, the user-accessed application server 110 may determine if the user interacted with the embedded application access interface (optional S514). If yes, the user-accessed application server 110 may send an update embedded application source data request to the embedded application server 112 (optional S516), which may forward the request to the embedded application repository 210 in order to update the embedded application source data in accordance with the user interaction (optional S516).

In some cases, the method 500 of FIG. 5A and the sequence of interactions illustrated in the signal diagram of FIG. 5B may enable seamless integration of the user-accessed application and the embedded application within a single frictionless integrated user interface. This integration may allow users to interact with both applications and enabling updating data in both the user-accessed application repository 215 and the embedded application repository 210 without the need for manual context switching between separate application windows.

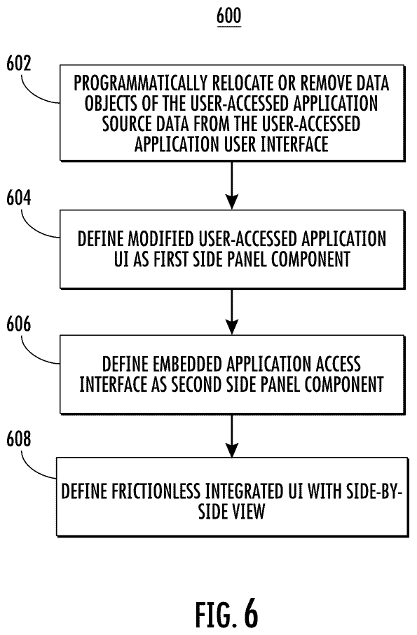

An example method 600 for causing transformation of the application display window to define the frictionless integrated user interface in accordance with Step 508 of FIG. 5A is illustrated in the flowchart of FIG. 6. In other words, the flowchart of FIG. 6 illustrates an example sequence of steps for transforming the application display window to define the frictionless integrated user interface with a side-by-side view that allows users to interact with and update the user-accessed application source data based on user interaction with the modified user-accessed application user interface and the embedded application source data based on user interaction with the embedded application access interface. The steps demonstrate how the interface components are reorganized and positioned to enable this integrated view in accordance with one example embodiment.

As with the method 500, method 600 may be implemented by the user-accessed application 108 and/or the user-accessed application server 110 in communication with the embedded application 106 and/or the embedded application server 112. For purposes of simplifying the description, the method 600 is described as performed by and from the perspective of the user-accessed application server 110. In this regard, performance of the operations may invoke one or more of memory 201, processor 202, input/output circuitry 203, communications circuitry 204, and/or user-accessed application circuitry 205.

The method 600 begins at step 602, which involves programmatically relocating or removing data objects of the user-accessed application source data from the user-accessed application user interface. For example, in some embodiments, step 602 may include removing a navigation panel from the user-accessed application user interface or relocating an issue context panel within the user-accessed application user interface. In still other embodiments, this step may involve generating a mobile view of the user-accessed application user interface to optimize the display of essential information within a reduced space.

At step 604, the method 600 involves defining the modified user-accessed application user interface as a first side panel component. This step may reorganize the remaining elements of the user-accessed application user interface into a compact layout suitable for side-by-side display with the embedded application access interface.

The method 600 proceeds to step 606, where the embedded application access interface is defined as a second side panel component. This step prepares the embedded application content for display alongside the modified user-accessed application user interface.

At step 608, the method 600 involves defining the frictionless integrated user interface with a side-by-side view. Step 608 may include positioning the modified user-accessed application user interface proximate to the embedded application access interface within the application display window, as depicted in FIG. 4D for example.

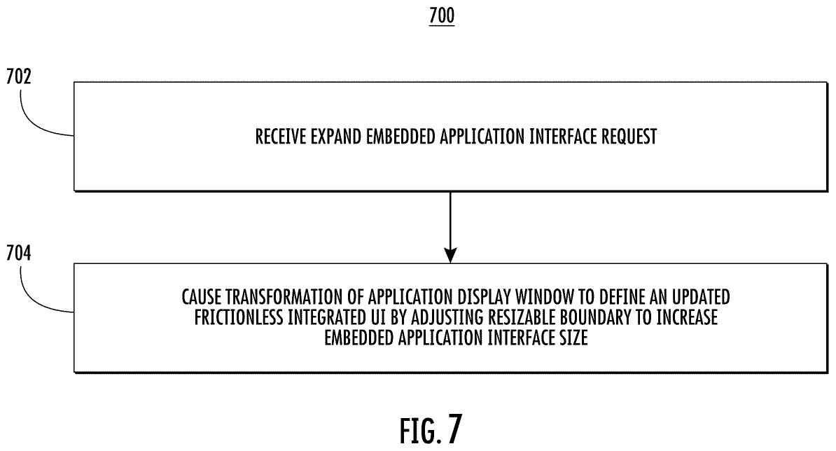

In some cases, the frictionless integrated user interface may be configured to allow expanding and minimizing of the embedded application access interface. FIG. 7 illustrates a method 700 for expanding a size of the embedded application access interface. The method 700 may be implemented by the user-accessed application 108 and/or the user-accessed application server 110 in communication with the embedded application 106 and/or the embedded application server 112. For purposes of simplifying the description, the method 700 is described as performed by and from the perspective of the user-accessed application server 110. In this regard, performance of the operations may invoke one or more of memory 201, processor 202, input/output circuitry 203, communications circuitry 204, and/or user-accessed application circuitry 205.

The method 700 begins at step 702, which involves receiving an expand embedded application interface request. For example, the user-accessed application server 110 may include means, such as the processor 202, input/output circuitry 203, communications circuitry 204, user-accessed application circuitry 205, or the like, for receiving the expand embedded application interface request. In some embodiments, this request may be received in response to user interaction with an embedded application access interface control engagement component displayed to the embedded application access interface as depicted in FIG. 4F.

The method 700 proceeds to step 704, which involves causing transformation of the application display window to define an updated frictionless integrated user interface. Such transformation may include adjusting a resizable boundary between the modified user-accessed application user interface and the embedded application access interface to increase the embedded application access interface size. This transformation may modify how the embedded application access interface is positioned within the frictionless integrated user interface displayed to the application display window. For example, in some embodiments, the expanded embedded application access interface may be displayed as nearly a full-screen overlay to the user-accessed application user interface within the updated frictionless integrated user interface as depicted in FIG. 4H. That is, a user may have interacted with the embedded application access interface control engagement component 425 and then selected a “Large Preview” option in the embedded application access interface control menu 435 as depicted in FIG. 4F, for example, resulting in the updated frictionless integrated user interface 450 as depicted in FIG. 4H, for example.

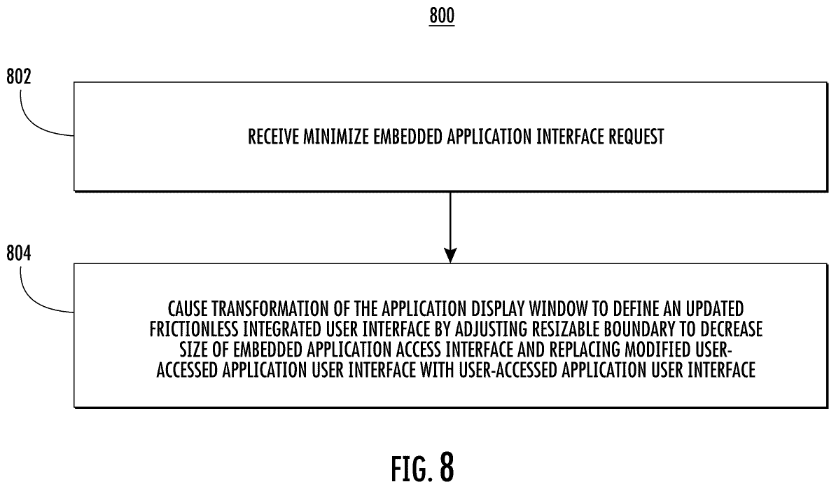

FIG. 8 illustrates a method 800 for minimizing the embedded application access interface. The method 800 may be implemented by the user-accessed application 108 and/or the user-accessed application server 110 in communication with the embedded application 106 and/or the embedded application server 112. For purposes of simplifying the description, the method 800 is described as performed by and from the perspective of the user-accessed application server 110. In this regard, performance of the operations may invoke one or more of memory 201, processor 202, input/output circuitry 203, communications circuitry 204, and/or user-accessed application circuitry 205.

The method 800 begins at step 802, which involves receiving a minimize embedded application interface request. For example, the user-accessed application server 110 may include means, such as the processor 202, input/output circuitry 203, communications circuitry 204, user-accessed application circuitry 205, or the like, for receiving the minimize embedded application interface request. In some cases, this request may be received in response to user interaction with the embedded application access interface control engagement component displayed to the embedded application access interface as depicted in FIG. 4F.

The method 800 proceeds to step 804, which involves causing transformation of the application display window to define an updated frictionless integrated user interface by adjusting a resizable boundary to decrease size of the embedded application access interface and replacing the modified user-accessed application user interface with the user-accessed application user interface. The transformation may modify how the embedded application access interface is positioned within the frictionless integrated user interface displayed in the application display window. For example, in some embodiments, the minimized embedded application access interface may be a collapsed interface component displayed or overlayed on a small portion of the user-accessed application user interface as depicted in FIG. 4G. That is, a user may have interacted with the embedded application access interface control engagement component 425 and then selected a “Minimize” option in the embedded application access interface control menu 435 as depicted in FIG. 4F, for example, resulting in the updated frictionless integrated user interface 450 as depicted in FIG. 4G, for example.

The methods 700 and 800 may allow users to dynamically adjust the size and visibility of the embedded application access interface within the frictionless integrated user interface of the single application display window. This functionality may provide users with flexibility in managing their workspace, allowing them to focus on either the user-accessed application content or the embedded application functionality as needed, all within a single application display window.

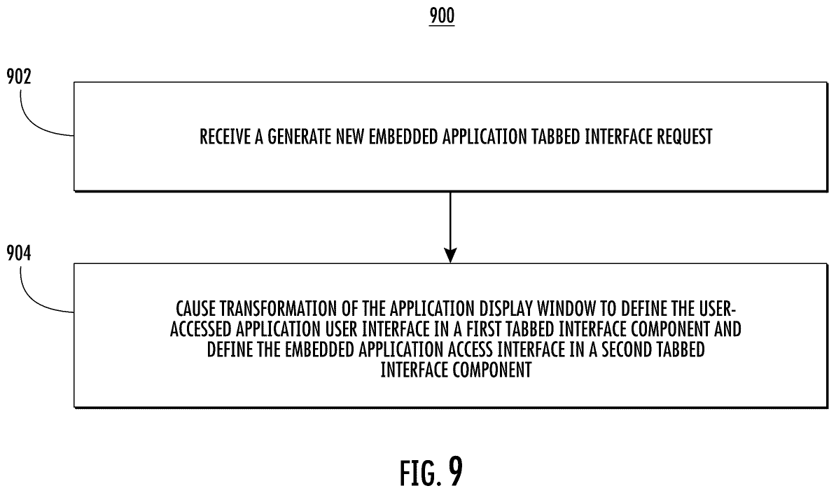

In some cases, the frictionless integrated user interface may comprise an embedded application tabbed interface engagement component. FIG. 9 illustrates a method 900 for defining the embedded application access interface in a new tabbed interface component. The method 900 may be implemented by the user-accessed application 108 and/or the user-accessed application server 110 in communication with the embedded application 106 and/or the embedded application server 112. For purposes of simplifying the description, the method 900 is described as performed by and from the perspective of the user-accessed application server 110. In this regard, performance of the operations may invoke one or more of memory 201, processor 202, input/output circuitry 203, communications circuitry 204, and/or user-accessed application circuitry 205.

The method 900 begins at step 902, which involves receiving a generate new embedded application tabbed interface request. For example, the user-accessed application server 110 may include means, such as the processor 202, the input/output circuitry 203, the communications circuitry 204, the user-accessed application circuitry 205, or the like, for receiving the generate new embedded application tabbed interface request. In some cases, this request may be received in response to user interaction with the embedded application tabbed interface engagement component (e.g., “Open in New Tab” button) of the frictionless integrated user interface.

The method 900 proceeds to step 904, which involves causing transformation of the application display window to define the user-accessed application user interface in a first tabbed interface component and define the embedded application access interface in a second tabbed interface component. The transformation may modify how the user-accessed application user interface and the embedded application access interface are positioned within the application display window by organizing them into separate tabbed interface components within the single application display window. In some cases, this transformation may allow users to switch between the user-accessed application user interface and the embedded application access interface using tab-like controls, similar to how users might switch between different tabs in a web browser. This configuration may provide a familiar and intuitive way for users to navigate between the two interfaces while maintaining the context of both applications within a single application display window. In some embodiments, the tabbed interface components may include visual indicators or labels to help users identify which tab corresponds to which interface or application. The tabs may also include additional functionality, such as the ability to close or reorder tabs, further enhancing the user's ability to customize their workspace within the single application display window. In some embodiments, the embedded application source data in the view of the new tabbed interface component may be the same or similar to those features or source data that is displayed as determined when generating the embedded application access interface, such as access to a page tree setting forth a hierarchy of the pages.

FIGS. 5A, 5B, and 6-9 thus illustrate flowcharts and signal diagrams describing the operation of apparatuses, methods, systems, and computer program products according to example embodiments contemplated herein. It will be understood that each flowchart block, and combinations of flowchart blocks, may be implemented by various means, such as hardware, firmware, processor, circuitry, and/or other devices associated with execution of software including one or more computer program instructions. For example, one or more of the operations described above may be implemented by an apparatus executing computer program instructions. In this regard, the computer program instructions may be stored by a memory 201 of the user-accessed application server 110 and executed by a processor 202 of the user-accessed application server 110. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

The flowchart blocks support combinations of means for performing the specified functions and combinations of operations for performing the specified functions. It will be understood that one or more blocks of the flowcharts, and combinations of blocks in the flowcharts, can be implemented by special purpose hardware-based computer systems which perform the specified functions, or combinations of special purpose hardware with computer instructions.

Thus, particular embodiments of the subject matter have been described. While this specification contains many specific implementation details, these should not be construed as limitations on the scope of the present disclosure or of what may be claimed, but rather as description of features specific to particular embodiments of present disclosure. Other embodiments are within the scope of the following claims. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products. Any operational step shown in broken lines in one or more flow diagrams illustrated herein are optional for purposes of the depicted embodiment.

In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

### CONCLUSION

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A computer-implemented method for defining a frictionless integrated user interface for rendering in association with a user-accessed application and an embedded application, the method comprising:
outputting a user-accessed application user interface for display within an application display window, wherein the user-accessed application user interface is configured to access and display user-accessed application source data of the user-accessed application supported by a first executable user-accessed application code base, and wherein the user-accessed application user interface comprises an embedded application engagement component;
receiving a contextual embedded application access request in response to user interaction with the embedded application engagement component of the user-accessed application user interface, wherein the contextual embedded application access request corresponds to the embedded application supported by a second executable embedded application code base;
accessing, via a data-driven connection between the user-accessed application and the embedded application, embedded application source data based on the contextual embedded application access request; and
causing transformation of the application display window to define a frictionless integrated user interface, wherein the frictionless integrated user interface defines a modified user-accessed application user interface positioned proximate an embedded application access interface within the application display window, wherein the frictionless integrated user interface is configured to enable updating of:
the user-accessed application source data based on user interaction with the modified user-accessed application user interface, and
the embedded application source data based on user interaction with the embedded application access interface.

2. The computer-implemented method of claim 1, wherein causing transformation of the application display window to define a frictionless integrated user interface comprises:
programmatically relocating or removing one or more data objects of the user-accessed application source data from the user-accessed application user interface to define the modified user-accessed application user interface as a first side panel component;
defining the embedded application access interface as a second side panel component; and
defining the frictionless integrated user interface with a side-by-side view of the modified user-accessed application user interface and the embedded application access interface.

3. The computer-implemented method of claim 2, wherein the user-accessed application user interface comprises a full-screen issue view for a project management application and the embedded application comprises a collaboration application.

4. The computer-implemented method of claim 3, wherein programmatically relocating or removing one or more data objects of the user-accessed application source data from the user-accessed application user interface comprises one or more of:
generating a mobile view of the user-accessed application user interface,
removing a navigation panel from the user-accessed application user interface, or
relocating, removing, or modifying an issue context panel user-accessed application user interface.

5. The computer-implemented method of claim 1, wherein the contextual embedded application access request comprises a create embedded application content request or an access linked embedded application content request.

6. The computer-implemented method of claim 1, wherein the frictionless integrated user interface includes a resizable boundary between the modified user-accessed application user interface and the embedded application access interface.

7. The computer-implemented method of claim 6, further comprising:
receiving an expand embedded application interface request; and
causing transformation of the application display window to define an updated frictionless integrated user interface by adjusting the resizable boundary to increase a size of the embedded application access interface.

8. The computer-implemented method of claim 6, further comprising:
receiving a minimize embedded application interface request; and
causing transformation of the application display window to define an updated frictionless integrated user interface by adjusting the resizable boundary to decrease a size of the embedded application access interface and replacing the modified user-accessed application user interface with the user-accessed application user interface.

9. The computer-implemented method of claim 1, wherein the frictionless integrated user interface comprises an embedded application tabbed interface engagement component, and the method further comprises:
receiving a generate new embedded application tabbed interface request in response to user interaction with embedded application tabbed interface engagement component of the frictionless integrated user interface; and
causing transformation of the application display window to define the user-accessed application user interface in a first tabbed interface component and define the embedded application access interface in a second tabbed interface component.

10. The computer-implemented method of claim 1, wherein causing transformation of the application display window to define the frictionless integrated user interface comprises automatically adjusting a layout of the modified user-accessed application user interface and the embedded application access interface based at least in part on an application display window width in pixels.

11. An apparatus for defining a frictionless integrated user interface for rendering in association with a user-accessed application and an embedded application, the apparatus comprising a processor, and a memory storing instructions that, when executed by the processor, cause the apparatus to:
output a user-accessed application user interface for display within an application display window, wherein the user-accessed application user interface is configured to access and display user-accessed application source data of the user-accessed application supported by a first executable user-accessed application code base, and wherein the user-accessed application user interface comprises an embedded application engagement component;
receive a contextual embedded application access request in response to user interaction with the embedded application engagement component of the user-accessed application user interface, wherein the contextual embedded application access request corresponds to the embedded application supported by a second executable embedded application code base;
access, via a data-driven connection between the user-accessed application and the embedded application, embedded application source data based on the contextual embedded application access request; and
cause transformation of the application display window to define a frictionless integrated user interface, wherein the frictionless integrated user interface programmatically relocates or removes one or more data objects of the user-accessed application source data from the user-accessed application user interface to define a modified user-accessed application user interface positioned proximate an embedded application access interface within the application display window, wherein the frictionless integrated user interface is configured to enable updating of:
the user-accessed application source data based on user interaction with the modified user-accessed application user interface, and
the embedded application source data based on user interaction with the embedded application access interface.

12. The apparatus of claim 11, wherein the instructions to cause transformation of the application display window to define a frictionless integrated user interface comprise instructions that, when executed by the processor, cause the apparatus to:
define the modified user-accessed application user interface as a first side panel component;
define the embedded application access interface as a second side panel component; and
define the frictionless integrated user interface with a side-by-side view of the modified user-accessed application user interface and the embedded application access interface.

13. The apparatus of claim 12, wherein the user-accessed application user interface comprises a full-screen issue view for a project management application and the embedded application comprises a collaboration application.

14. The apparatus of claim 13, wherein the instructions to programmatically relocate or remove one or more data objects of the user-accessed application source data from the user-accessed application user interface comprise instructions that, when executed by the processor, cause the apparatus to perform one or more of:
generate a mobile view of the user-accessed application user interface,
remove a navigation panel from the user-accessed application user interface, or
relocate, remove, or modify an issue context panel user-accessed application user interface.

15. The apparatus of claim 11, wherein the contextual embedded application access request comprises a create embedded application content request or an access linked embedded application content request.

16. The apparatus of claim 11, wherein the frictionless integrated user interface includes a resizable boundary between the modified user-accessed application user interface and the embedded application access interface.

17. The apparatus of claim 16, wherein the memory stores further instructions that, when executed by the processor, cause the apparatus to:
receive an expand embedded application interface request; and
cause transformation of the application display window to define an updated frictionless integrated user interface by adjusting the resizable boundary to increase a size of the embedded application access interface.

18. The apparatus of claim 16, wherein the memory stores further instructions that, when executed by the processor, cause the apparatus to:
receive a minimize embedded application interface request; and
cause transformation of the application display window to define an updated frictionless integrated user interface by adjusting the resizable boundary to decrease a size of the embedded application access interface and replacing the modified user-accessed application user interface with the user-accessed application user interface.

19. The apparatus of claim 11, wherein the frictionless integrated user interface comprises an embedded application tabbed interface engagement component, and wherein the memory stores further instructions that, when executed by the processor, cause the apparatus to:
receive a generate new embedded application tabbed interface request in response to user interaction with embedded application tabbed interface engagement component of the frictionless integrated user interface; and
cause transformation of the application display window to define the user-accessed application user interface in a first tabbed interface component and define the embedded application access interface in a second tabbed interface component.

20. (canceled)

21. A computer program product comprising at least one non-transitory computer-readable storage medium having computer-readable program code portions stored therein, the computer-readable program code portions comprising executable portions configured to:
output a user-accessed application user interface for display within an application display window, wherein the user-accessed application user interface is configured to access and display user-accessed application source data of a user-accessed application supported by a first executable user-accessed application code base, and wherein the user-accessed application user interface comprises an embedded application engagement component;
receive a contextual embedded application access request in response to user interaction with the embedded application engagement component of the user-accessed application user interface, wherein the contextual embedded application access request corresponds to an embedded application supported by a second executable embedded application code base, and wherein the contextual embedded application access request comprises a create embedded application content request or an access linked embedded application content request;
access, via a data-driven connection between the user-accessed application and the embedded application, embedded application source data based on the contextual embedded application access request; and
cause transformation of the application display window to define a frictionless integrated user interface, wherein the frictionless integrated user interface defines a modified user-accessed application user interface positioned proximate an embedded application access interface within the application display window, wherein the frictionless integrated user interface is configured to enable updating of:
the user-accessed application source data based on user interaction with the modified user-accessed application user interface, and
the embedded application source data based on user interaction with the embedded application access interface.

22.-29. (canceled)
